(19) United States
(12) Patent Application Publication
(10) Pub. No.: US 2023/0072246 A1
(43) Pub. Date: Mar. 9, 2023

(54) WORKFLOW INTERFACE IN A COMMUNICATION PLATFORM

(71) Applicant: Slack Technologies, Inc., San Francisco, CA (US)

(72) Inventors: Angela Kirchhof, Denver, CO (US); Michael Brevoort, Littleton, CO (US); Kyle Turman, Oakland, CA (US); Carolyn Selheim-Miller, Oakland, CA (US); Vanessa Bahk, Saratoga, CA (US)

(73) Assignee: Slack Technologies, Inc.

(21) Appl. No.: 17/468,348

(22) Filed: Sep. 7, 2021

(51) Int. Cl. H04L 29/08; G06F 3/0484

(52) U.S. Cl. CPC H04L 67/306; H04L 67/20; G06F 3/04842

(57) ABSTRACT

Techniques for providing a simplified and expedited means by which a user can associate a workflow with a user account of a communication platform are described herein. The communication platform stores a plurality of previously generated workflows that can be associated with the user account. A workflow includes a task, or sequences of steps, that can be performed by the communication platform and/or a third-party resource. The communication platform provides data associated with select workflows (e.g., based on relevance) to a user via an interface. The user may then select a workflow for association with a user account via the interface. In some examples, the communication platform can enable the user to customize the workflow to improve relevance thereof to the user account. Based on an occurrence of a triggering action associated with a workflow, the communication platform causes a task associated with the workflow to be performed.

### TECHNICAL FIELD

Communication platforms are becoming increasingly more popular for facilitating work-related communications, such as for project collaboration within a single organization and across two or more organizations. To improve functionality and collaboration, some communication platforms enable users to manually build workflows by coding a sequence of steps or providing instructions that cause the communication platform and/or a third-party resource to perform a particular function. For example, a user can manually create a workflow to cause the communication platform to send an automated message to new user accounts that have recently been associated with a particular communication channel. However, a requirement to manually generate a workflow in a communication platform can prevent users who are unfamiliar with generating computing instructions and/or who are not willing to invest time in the often onerous process of manual workflow generation. As such, these conventional systems limit the number of users who may incorporate workflows into their account, thereby reducing functionality in many accounts across the communication platform, limiting an overall effectiveness thereof, and potentially leading to a negative user experience.

### BRIEF DESCRIPTION OF THE DRAWINGS

The detailed description is described with reference to the accompanying figures. In the figures, the left-most digit of a reference number identifies the figure in which the reference number first appears. The use of the same reference numbers in different figures indicates similar or identical components or features. The figures are not drawn to scale.

FIG. 1 is a block diagram illustrating an example system of computing devices usable to implement example techniques described herein.

FIG. 2 is a schematic view of an example user interface for associated with a communication platform, as described herein.

FIGS. 3A-3E illustrate example user interfaces for enabling access to one or more workflows for incorporation into a user account, as described herein.

FIGS. 4A and 4B illustrate example user interfaces for providing detailed information associated with a workflow, as described herein.

FIGS. 5A-5C illustrate example user interfaces for providing details regarding the functionality of a workflow, as described herein.

FIGS. 6A and 6B illustrate example user interfaces for customizing a workflow, as described herein.

FIG. 7 illustrates an example process for associating a workflow with a user account, as described herein.

FIG. 8 illustrates an example process for causing a task associated with a workflow to be performed based in part on an occurrence of a triggering action, as described herein.

FIG. 9 illustrates an example process for filtering workflows for presentation to a user via an interface, as described herein.

### DETAILED DESCRIPTION

Techniques for providing a simplified and expedited means by which a user can associate a workflow (e.g., integration) with a user account of a communication platform are described herein. The communication platform can be a group-based communication platform, a channel-based messaging platform and/or any other platform for facilitating communication between and among users. In an example, the communication platform can store a plurality of previously generated workflows that can be associated with a user account. The plurality of workflows can include tasks, or sequences of steps, that can be performed in whole or in part by the communication platform, a third-party service provider (e.g., third-party application), and/or a first-party application (e.g., application associated with an organization of a user). That is, a workflow can include an automation of a task that, in some examples, was previously performed manually by a user of the communication platform. In some examples, the user can submit a request to view an interface associated with the plurality of workflows. In response to receiving the request, the communication platform can provide data associated with at least a portion of the plurality of workflows to the user via the interface. The user may then select a workflow for association with a user account via the interface. In some examples, the communication platform can enable the user to customize the workflow to improve relevance thereof to the user account. For example, in response to receiving, from a user, a request to view the interface, the communication platform can identify one or more recommended workflows for the user and/or one or more most popular (e.g., most often incorporated into user accounts) workflows within the communication platform. The user can select and customize a particular workflow to be associated with the user account. In response to receiving an indication that a triggering action associated with a workflow has occurred, the communication platform can cause a task associated with the workflow to be performed.

In existing technologies, a communication platform can enable a user to manually build a workflow to be associated with a user account. The process of manually generating a workflow can include multiple steps of user input to create and/or customize the workflow to be associated with a user account. Once stored in association with the user account, a task associated with the workflow may be performed with respect to the user account. However, the task and/or workflow may not be available to other users of the communication platform. As such, for another user to associate a same or similar workflow with their user account, the other user must perform the same or similar steps of manually generating the workflow and associating the workflow with their individual account. However, the manual generation of the workflows can require a threshold level of knowledge and comfort generating computing instructions and can take a significant amount of time. Additionally, requiring each user to manually generate each workflow to be associated with respective user accounts can be inefficient and waste a significant amount of computing resources.

Techniques described herein are directed to enabling users of the communication platform access to a plurality of previously generated workflows that are associated with the communication platform. The plurality of previously generated workflows can include workflows that are generated by other users of the communication platform, by a programmer associated with the communication platform, by an organization member associated with a first-party application of the organization, and/or by a third-party resource. In some examples, the communication platform can provide the plurality of workflows in an interface for the user to browse and select one or more workflows to associate with a user account thereof. In at least one example, in response to receiving a request, from a user, to view the interface, the communication platform can identify a portion of the plurality of workflows that may be relevant to the user. As non-limiting examples, the portion of the plurality of workflows that may be relevant to the user can include workflows that are recommended for the user and/or workflows popular with other user accounts.

In various examples, the interface can provide a means by which the user can search for a particular type of workflow and/or filter results to identify one or more workflows that are relevant to the search. As non-limiting examples, the communication platform can enable filtering a search based on a source of the workflow (e.g., entity that created and/or is associated with performing a task associated with the workflow, such as the communication platform, a third-party resource, third-party application, etc.), a number of steps associated with the workflow, workflows associated with team management, managing meetings or other group interactions, tracking statistics and/or other metrics associated with the communication platform (e.g., statistics and/or metrics associated with use of the communication platform, communications between users, virtual spaces, etc.), information and/or error updates, creating tasks for other users to perform, interpersonal workflows (e.g., workflows to encourage interactions between users, etc.), automatic submissions, generating reports, personal workflows (e.g., related to personal actions and/or interactions), group affiliations (e.g., workflows used by others on my team), based on role (e.g., workflows used by others with similar title or role in an organization), based on creation data, and/or the like.

In at least one example, each workflow illustrated via the interface can be associated with a task, or a series of steps to accomplish a particular outcome. Individual steps in the series of steps can be performed by the communication platform and/or a third-party resource (e.g., third-party application). For example, a workflow can be associated with a task of providing notifications regarding updates to a particular third-party application. The task may include a first step of causing the third-party application to provide data associated with an update to the communication platform and a second step of the communication platform causing a presentation of a notification associated with the update. For another example, a workflow can be associated with the communication application setting up regular team meetings via the communication platform on a particular interval as designated by a user (e.g., in a customization of the workflow). In some examples, the task may include a reminder for an associated user to perform an action, such as to connect with team members (e.g., send check-in messages) on a regular interval.

In various examples, the communication platform can be configured to provide a brief description of the task associated with each workflow presented via the interface, such as to inform a viewing user of the nature of the workflow. In some examples, the interface can include a selectable option associated with each workflow, such as to provide the user with additional details associated with a selected workflow. The additional details can include implementation details, information associated with entities performing each step in a series of steps (e.g., information associated with how the workflow is performed), triggering actions to cause the workflow to be initiated, one or more workflows that are related to the selected workflow, and the like.

In various examples, the interface can provide a means by which the user can cause the selected workflow to be associated with the user account. In some examples, the user may submit a request via the interface for the workflow to be installed on the user account. In response to receiving the request, the communication platform can associate the interface with the user account. Additionally, in some examples, the communication platform can cause a request for implementation details to be presented via the interface. In such examples, the user can submit the implementation details, such as to customize the workflow for the user. In some examples, implementation details can include a workspace, communication channel, board, or other virtual space of the communication platform with which to associate the workflow. In some examples, the implementation details can include a particular day (e.g., day of the month, day of the week, etc.) and/or time to associate with the workflow (e.g., for the task associated with the workflow to be performed). In some examples, the implementation details can include a triggering action (e.g., trigger) associated with the workflow. In such examples, the communication platform can enable the user to customize a particular triggering action that causes the workflow to be initiated, advanced (e.g., intermediate step associated with progressing through the workflow), and/or completed.

Additionally, the communication platform can be configured to enable the user to select another workflow to associate with the selected workflow. As discussed above, in response to an indication of selection of a particular workflow (e.g., the selected workflow), the communication platform can identify one or more other related workflows. The related workflows can include other workflows that may supplement and/or augment the selected workflow. In some examples, the communication platform can enable the user to additionally or alternatively associate the related workflow with the user account and/or the originally selected workflow. For example, the user can select a first workflow to associate with the user account. The communication platform can cause a second, related workflow to be presented in association with the first workflow. The communication platform can cause a presentation of a first selectable option to associate the second workflow with the user account independently of the first workflow and/or a second selectable option to associate the second workflow with the first workflow in the user account, such that the second workflow is performed in association with (e.g., before, after, concurrently) the first workflow.

Techniques described herein can improve the functioning of various computing devices associated with the communication platform. As discussed above, some conventional communication platforms enable users to create workflows to associate with their user accounts. For example, a conventional communication platform could provide a means by which a user could manually program a workflow into their user account. This conventional workflow generation process was onerous and time consuming and resulted in a workflow that was applied to a particular user account (e.g., not transferrable or shareable with other users). As such, each user who desired to associate a similar workflow would have to go through the onerous process of generating the workflow, thereby utilizing additional time and computing resources of both respective user computing devices and communication platform computing devices (e.g., server computing device). Unlike the conventional systems, the techniques described herein enable access to previously generated workflows via an interface of the communication platform, such as to enable any user to easily select, customize, and associate an existing workflow with their user account. At least because users are no longer required manually generate each workflow prior to associating them with their user account, the techniques described herein reduce an overall amount of computing resources and memory required by individual user computing devices and the communication platform computing devices, to associate workflows with user accounts. As such, the techniques described herein improve the functioning of both user computing devices and communication platform computing devices.

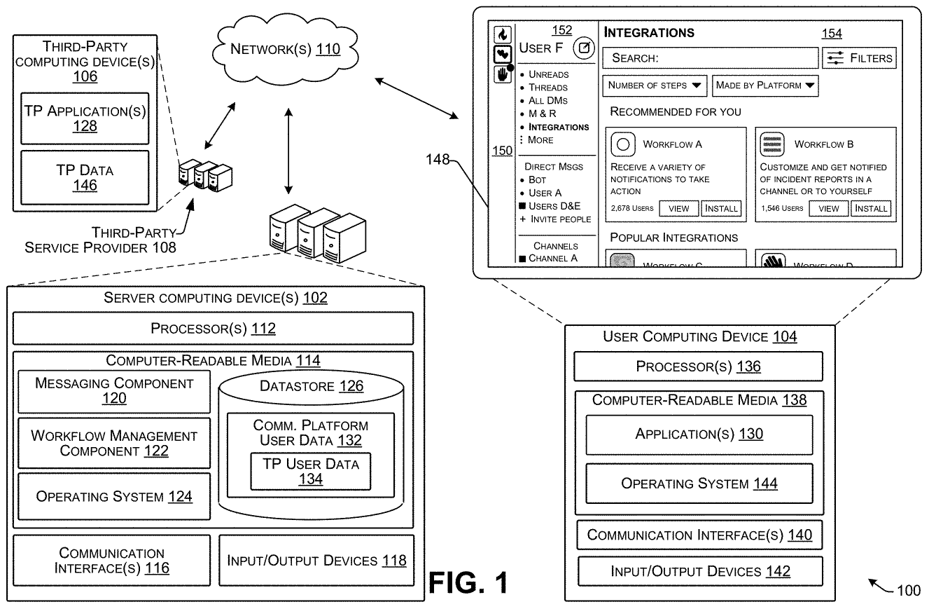

Furthermore, from the user experience perspective, techniques described herein greatly enhance the ease of associating a variety of workflows with a user account. As discussed above, conventional system required users to manually create each workflow to be associated with a user account. The manual workflow creation was an onerous process that was sometimes limited to users with a threshold level of experience with computer programming and/or comfort with the communication platform. Instead of requiring the manual generation of each workflow by each user, the techniques described herein provide an interface with a plurality of workflows available to a user to associated with the user account, such as to improve functionality of the communication platform with respect to each user, and/or to improve an overall user experience with the communication platform. Additionally, the communication platform can be configured to identify workflows that may be most relevant to the user, and can cause a presentation thereof. As such, each user may be presented with a plurality of relevant workflows that they can associate with their user account to further increase the ease and efficiency by which the user may associate a variety of workflows with their account. By providing relevant workflows to the user, the communication platform may reduce an amount of processing power and memory required to conduct a search for a particular workflow, thereby improving the performance of an associated computing device. Additional details and examples are described below with reference to FIGS. 1-9.

FIG. 1 illustrates an example system 100 for performing techniques described herein. In at least one example, the example system 100 can be associated with a communication platform that can leverage a network-based computing system to enable users of the communication platform to exchange data. In at least one example, the communication platform can be “group-based” such that the platform, and associated systems, communication channels, messages, and/or virtual spaces, have security (that can be defined by permissions) to limit access to a defined group of users. In some examples, such groups of users can be defined by group identifiers, which can be associated with common access credentials, domains, or the like. In some examples, the communication platform can be a hub, offering a secure and private virtual space to enable users to chat, meet, call, collaborate, transfer files or other data, or otherwise communicate between or among each other. In various examples, each group can be associated with a workspace, enabling users associated with the group to chat, meet, call, collaborate, transfer files or other data, or otherwise communicate between or among each other in a secure and private virtual space. In some examples, members of a group, and thus a workspace, can be associated with a same organization. In some examples, members of a group, and thus a workspace, can be associated with different organizations (e.g., entities with different organization identifiers).

In at least one example, the example system 100 can include one or more server computing devices (or “server(s)”) 102. In at least one example, the server(s) 102 can include one or more servers or other types of computing devices that can be embodied in any number of ways. For example, in the example of a server, the functional components and data can be implemented on a single server, a cluster of servers, a server farm or data center, a cloud-hosted computing service, a cloud-hosted storage service, and so forth, although other computer architectures can additionally or alternatively be used.

In at least one example, the server(s) 102 can communicate with a user computing device 104 and/or one or more third-party computing devices 106 associated with a third-party service provider 108 (e.g., third-party resource) via one or more network(s) 110. That is, the server(s) 102, the user computing device 104, and the third-party computing device(s) 106 can transmit, receive, and/or store data (e.g., content, information, or the like) using the network(s) 110, as described herein. The user computing device 104 and the third-party computing device(s) 106 can be any suitable type of computing device, e.g., portable, semi-portable, semi-stationary, or stationary. Some examples of the third-party computing device(s) 106 can include a server computing device, such as that described above with regard to the server(s) 102, a desktop computing device, a terminal computing device, or the like.

Some examples of the user computing device 104 can include a tablet computing device, a smart phone, a mobile communication device, a laptop, a netbook, a desktop computing device, a terminal computing device, a wearable computing device, an augmented reality device, an Internet of Things (IOT) device, or any other computing device capable of sending communications and performing the functions according to the techniques described herein. While a single user computing device 104 is shown, in practice, the example system 100 can include multiple (e.g., tens of, hundreds of, thousands of, millions of) user computing devices. In at least one example, user computing devices, such as the user computing device 104, can be operable by users to, among other things, access communication services via the communication platform. A user can be an individual, a group of individuals, an employer, an enterprise, an organization, or the like.

The network(s) 110 can include, but are not limited to, any type of network known in the art, such as a local area network or a wide area network, the Internet, a wireless network, a cellular network, a local wireless network, Wi-Fi and/or close-range wireless communications, Bluetooth®, Bluetooth Low Energy (BLE), Near Field Communication (NFC), a wired network, or any other such network, or any combination thereof. Components used for such communications can depend at least in part upon the type of network, the environment selected, or both. Protocols for communicating over such network(s) 110 are well known and are not discussed herein in detail.

In at least one example, the server(s) 102 can include one or more processors 112, computer-readable media 114, one or more communication interfaces 116, and input/output devices 118. Though not illustrated in FIG. 1, the third-party computing device(s) 106 can additionally include one or more processors, such as processor(s) 112, computer-readable media, such as computer-readable media 114, communication interface(s) 116, such as communication interface(s) 116, input/output devices, such as input/output devices 118.

In at least one example, each processor of the processor(s) 112 can be a single processing unit or multiple processing units and can include single or multiple computing units or multiple processing cores. The processor(s) 112 can be implemented as one or more microprocessors, microcomputers, microcontrollers, digital signal processors, central processing units (CPUs), graphics processing units (GPUs), state machines, logic circuitries, and/or any devices that manipulate signals based on operational instructions. For example, the processor(s) 112 can be one or more hardware processors and/or logic circuits of any suitable type specifically programmed or configured to execute the algorithms and processes described herein. The processor(s) 112 can be configured to fetch and execute computer-readable instructions stored in the computer-readable media, which can program the processor(s) to perform the functions described herein.

The computer-readable media 114 can include volatile and nonvolatile memory and/or removable and non-removable media implemented in any type of technology for storage of data, such as computer-readable instructions, data structures, program modules, or other data. Such computer-readable media 114 can include, but is not limited to, RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired data and that can be accessed by a computing device. Depending on the configuration of the server(s) 102, the computer-readable media 114 can be a type of computer-readable storage media and/or can be a tangible non-transitory media to the extent that when mentioned, non-transitory computer-readable media exclude media such as energy, carrier signals, electromagnetic waves, and signals per se.

The computer-readable media 114 can be used to store any number of functional components that are executable by the processor(s) 112. In many implementations, these functional components comprise instructions or programs that are executable by the processor(s) 112 and that, when executed, specifically configure the processor(s) 112 to perform the actions attributed above to the server(s) 102. Functional components stored in the computer-readable media can optionally include a messaging component 120, a workflow management component 122, an operating system 124, and a datastore 126.

In at least one example, the messaging component 120 can process messages between users. That is, in at least one example, the messaging component 120 can receive an outgoing message from a user computing device 104 and can send the message as an incoming message to a second user computing device 104. The messages can include direct messages sent from an originating user to one or more specified users and/or communication channel messages sent via a communication channel from the originating user to the one or more users associated with the communication channel. The communication channel, or virtual space, can be a data route used for exchanging data between and among systems and devices associated with the communication platform. In at least one example, the messaging component 120 can establish a communication channel, board, huddle (e.g., audio and/or video communication link) between and among various user computing devices, allowing the user computing devices to communicate and share data between and among each other. In at least one example, the messaging component 120 can manage such communications and/or sharing of data. In some examples, data associated with a communication channel can be presented via a user interface.

In at least one example, the workflow management component 122 can provide an interface via which a user can access data associated with a plurality of workflows. The plurality of workflows can include workflows that have been previously generated in association with the communication platform, such as by a user of the communication platform, a programmer of the communication platform, by an organization member associated with a first-party application of the organization, and/or by a third-party service provider 108. In some examples, the workflow may be provided to the communication platform from the third-party service provider 108 (e.g., from the third-party computing device(s) 106) and/or from a computing device associated with the organization member. In such examples, the third-party service provider and/or organization (e.g., first party) member can submit one or more generated workflows to the communication platform, such as for incorporation into the communication platform. A workflow can include a task, or a sequence of steps completed to accomplish a particular outcome (e.g., a desired outcome). The task can include data collection, message transmission, event or mention reactions, and/or the like. In at least one example, the task can include a task that was previously performed manually by a user of the communication platform that, with incorporation or association of the workflow with a user account, is performed automatically, such as without input or further instruction from the user. In some examples, the workflow management component 122 can be configured to perform the task and/or at least one step of the sequence of steps. For example, the workflow can include a task to send a welcome message to new members of a particular communication channel. In response to receiving an indication that a new member has joined the particular channel (e.g., triggering action or trigger), the workflow management component 122 can cause the messaging component 120 to present a welcome message to at least the new member via a messaging interface in association with the particular channel.

In some examples, the task and/or individual steps associated therewith can be performed by a third-party service provider 108, such as a third-party application 128 used in association with the communication platform. The third-party application 128 can include an application that can be accessible via and/or in association with a communication platform application 130. In some examples, the third-party service provider 108 (e.g., third-party application 128) can perform a task and/or step(s) of a workflow associated with the communication platform, such as in response to identifying an occurrence triggering action associated therewith. In some examples, the workflow management component 122 can send an instruction to the third-party service provider 108 to perform the task in response to identifying the occurrence of the triggering action. In such examples, the workflow management component 122 can cause the third-party service provider 108 to perform the task and/or step(s) of the workflow.

In some examples, the third-party service provider 108 can perform the task and/or step(s) of the workflow and can send data associated therewith to the workflow management component 122, such as for display via the user computing device 104. In some examples, the third-party service provider 108 can additionally send instructions to cause the workflow management component 122 to present the data in a particular manner.

In at least one example, the workflow management component 122 can identify one or more workflows associated with the communication platform that are configured for association with a user account. The workflow(s) can include templates stored in the datastore 126, that can be customized for use in association with a particular user account. In some examples, the workflow(s) can be identified based on permissions associated with the user account. For example, a user account and/or an organization of the user (e.g., via an administrative account) may establish permissions associated with particular workflows, such that select workflows may be available to be associated with a user account, but other workflows may not. Based on the permissions, the workflow management component 122 can cause the select workflows to be presented via the interface.

Additionally or alternatively, in some examples, the workflow management component 122 can identify workflow(s) based on characteristics of the user account. In such examples, the workflow management component 122 can be configured to present workflow(s) that are relevant to the user. The characteristics can be stored in association with user data 132 in the datastore 126. The characteristics can include an organization identifier associated with an organization of the user, a group or team identifier, a type of user account (e.g., paid, unpaid, temporary, permanent, etc.), employment data (e.g., job position, title, team affiliation, project affiliation, employment location, etc.), qualification (e.g., education, certifications, etc.), third-party application integration (e.g., integration stored in association with user account), user interests (e.g., personal interests, work-related interests, etc.), demographic data (e.g., age, home location, etc.), interaction data (e.g., frequency and/or recency of interactions with other users, with virtual spaces (e.g., communication channels, direct messaging instances, boards, audio and/or video conversations, etc.), and/or other characteristics of the user account. For example, the identified workflow(s) can include workflow(s) that are associated with an organization. Based on a determination that the user account has associated therewith an organization identifier associated with the organization, the workflow management component 122 can cause workflow(s) associated with the organization to be presented via the interface.

In various examples, the workflow management component 122 can identify one or more workflows to recommend to the user based on the characteristic(s). In some examples, the workflow management component 122 can identify the workflow(s) to recommend based on workflows that have been selected by other users for association with respective user accounts. In some examples, the workflow management component 122 can identify the workflow(s) based on those associated with one or more user accounts that are similar to the user account of the user based on respective characteristics. In some examples, the similarity can be determined based on the user account and the other user accounts sharing a same characteristic, such as a same organization identifier, team identifier, job position or title, or the like. In some examples, the similarity can be determined utilizing statistical analysis, machine learning techniques, and/or other techniques that analyze one or more characteristics to determine a similarity. In some examples, the workflow management component 122 can identify similar user accounts based on a determination that a similarity between the user and the similar user accounts is at or above a threshold similarity. In some examples, the similarity can be determined based on a threshold number and/or type of characteristics being the same or similar between the respective user accounts.

In some examples, the workflow management component 122 can identify the workflow(s) to recommend to the user based on a popularity thereof across the communication platform and/or a portion thereof. The popularity of a particular workflow can be determined based on a number of users of the communication platform that have associated the particular workflow with their user accounts. In some examples, the popularity can be determined based on association with similar user accounts. In such examples, the workflow management component 122 can identify the most popular workflow(s) associated with user accounts that are similar to the user account of the user. In various examples, the workflow management component 122 can cause a presentation of data associated with a pre-determined number of popular workflows via the interface. In such examples, the workflow management component 122 can cause the pre-determined number of the most popular workflows to be presented to the user via the interface. In some examples, the workflow management component 122 can cause a presentation of data associated with workflows that have been associated with a threshold number of user accounts (e.g., 100, 500, 1000, 2000, etc.). In various examples, the workflows can be presented in a ranked order (e.g., top ranked), such as based on popularity, number of integrations with user accounts, and/or the like. In some examples, the workflow management component 122 can be configured to present a number (e.g., 20, 25, 50, 100, etc.) of top-ranked workflows. Non-limiting examples of the data associated with a workflow presented via the interface can include a name of the workflow, an icon associated with the workflow a brief description of the workflow, a source of the workflow (e.g., communication platform, third-party service provider 108, etc.) a number of users accounts that are associated with the workflow, and/or the like.

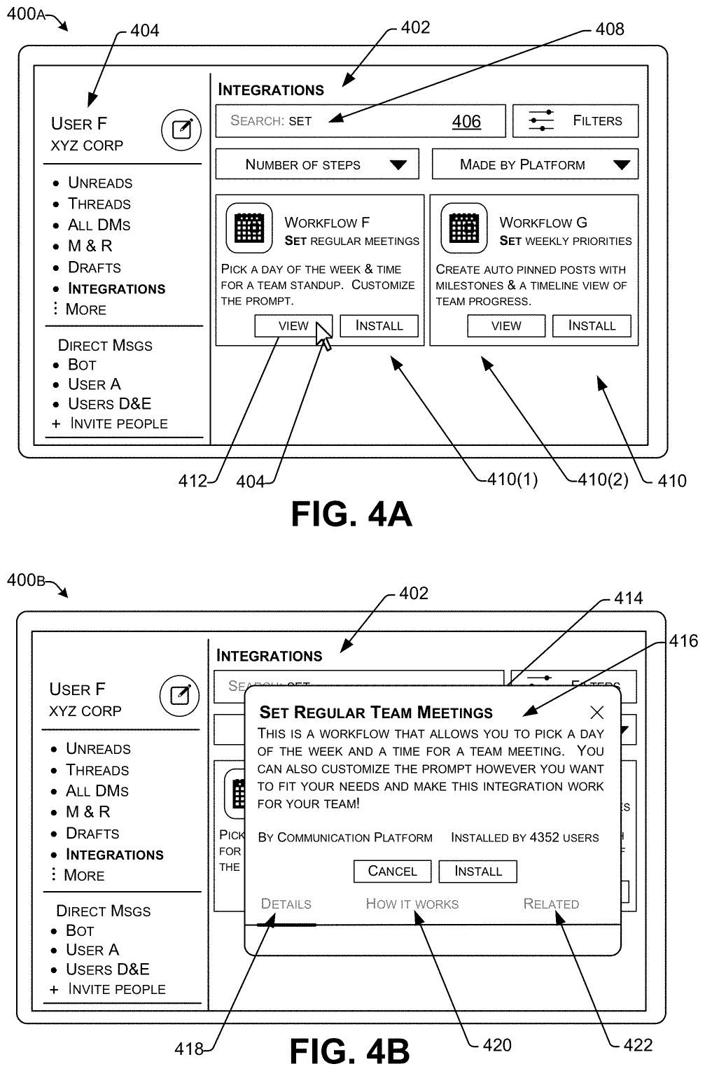

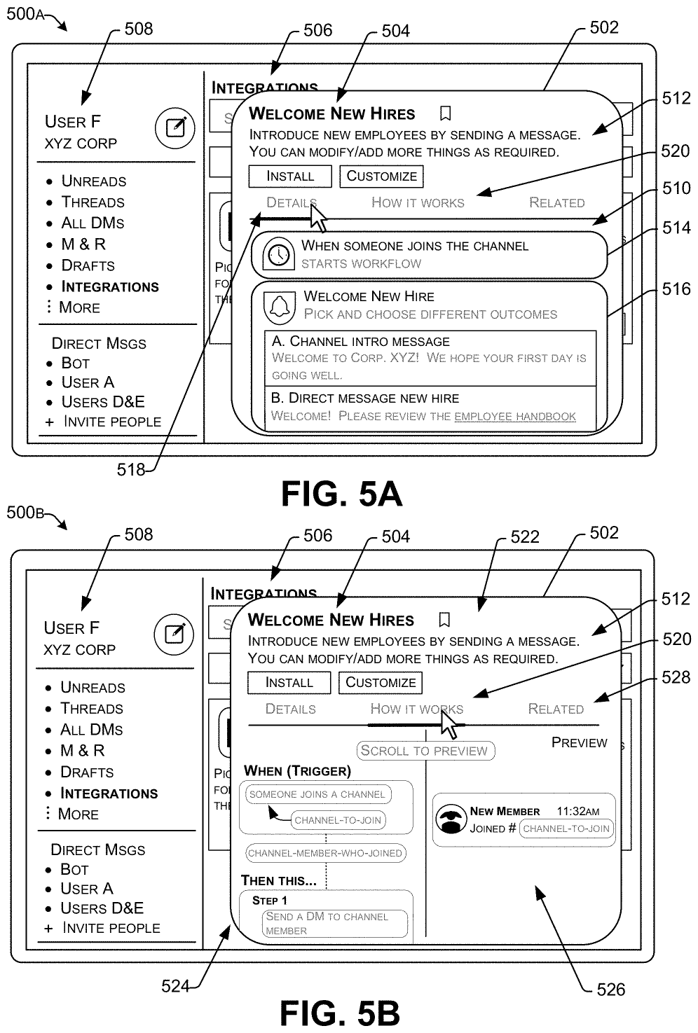

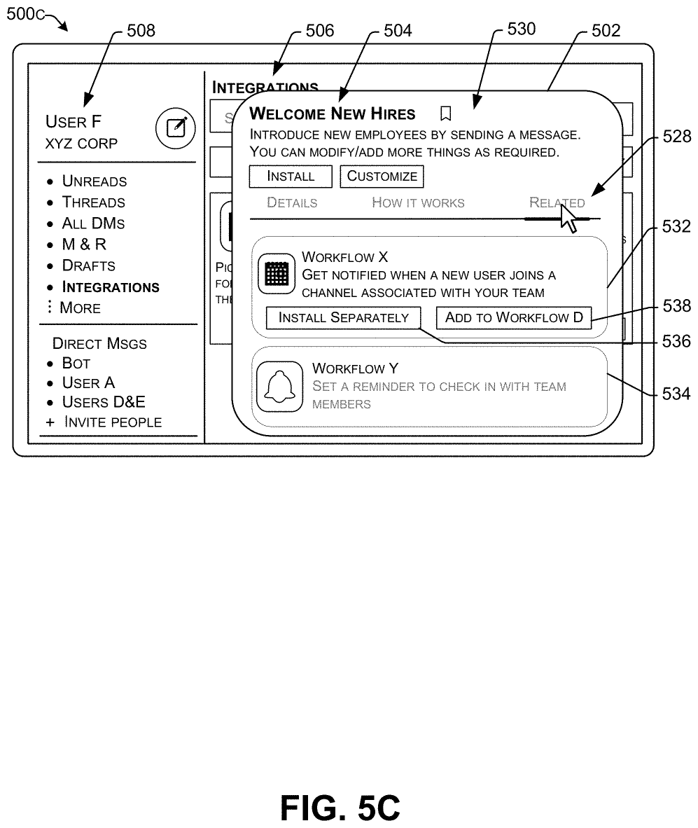

In some examples, in response to receiving a request to view additional information about a particular workflow, the workflow management component 122 can cause the additional information to be presented via the interface. As will be discussed below in more detail with regard to at least FIGS. 4B, and 5A-5C, the additional information can include can include a detailed explanation of the workflow, implementation details, information associated with entities performing each step in a series of steps (e.g., information associated with how the workflow is performed), triggering actions to cause the workflow to be initiated, one or more workflows that are related to the selected workflow, and the like.

In various examples, the workflow management component 122 can be configured to receive a request, from the user account of the user, to associate the workflow with the user account (e.g., install the workflow in association with the user account). In response to receiving the request, the workflow management component 122 can associate the workflow with the user account. In various examples, the workflow management component 122 can access user characteristics, and/or other data associated with the user, and complete a generic (e.g., common) template that is associated with the selected workflow. As such, the workflow management component 122 can be configured to automatically customize the workflow for association with the user account. The workflow and/or task associated therewith can be performed based in part on the completed template that is stored in association with the user account.

Additionally, in some examples, the workflow management component 122 can cause a request for implementation details to be presented via the interface. In such examples, the workflow management component 122 can provide a means by which the user can submit the implementation details, such as to customize the workflow (e.g., the template) for the user and/or user account. In some examples, implementation details can include a workspace, communication channel, board, or other virtual space of the communication platform with which to associate the workflow. In some examples, the implementation details can include a particular day (e.g., day of the month, day of the week, etc.) and/or time to associate with the workflow (e.g., for the task associated with the workflow to be performed). In some examples, the implementation details can include a triggering action (e.g., trigger) associated with the workflow. In such examples, the workflow management component 122 can enable the user to customize a particular triggering action that causes the workflow to be initiated and/or completed. In various examples, the workflow management component can complete the template based on the customization (e.g., implementation details) and store the customized template of the workflow in association with the user account.

In some examples, in response to receiving an indication of selection of a workflow, such as to review additional details associated therewith or to associated with the user account, the workflow management component 122 can identify one or more related workflows to the selected workflow. The related workflows can include other workflows that may supplement and/or augment the selected workflow. For example, the selected workflow can be associated with a first task and a related workflow can be associated with a second, subsequent task that is related to the first task. As will be discussed in greater detail with regard to FIG. 5C, the workflow management component 122 can enable the user to associate the related workflow with the user account of the user and/or associate the related workflow with the originally selected workflow. For example, the user can select a first workflow to associate with the user account. The communication platform can cause a second, related workflow to be presented in association with the first workflow. The communication platform can cause a presentation of a first selectable option to associate the second workflow with the user account independently of the first workflow and/or a second selectable option to associate the second workflow with the first workflow in the user account, such that the second workflow is performed in association with (e.g., before, after, concurrently) the first workflow. In response to receiving an indication of selection of the second selectable option, the workflow management component 122 can combine the tasks and/or series of steps of the first workflow with those of the second workflow.

In various examples, in response to receiving a request to associate a workflow with a user account, the workflow management component 122 can store the workflow in association with the user account, such as in the user data 132 of the datastore 126. In at least one example, the datastore 126 can be configured to store data that is accessible, downloadable, manageable, and updatable. In some examples, the datastore 126 can be integrated with the server(s) 102, as shown in FIG. 1. In other examples, the datastore 126 can be located remotely from the server(s) 102 and can be accessible to the server(s) 102 and/or user computing device(s), such as the user computing device 104. Additional or alternative data can be stored in the datastore 126 and/or in one or more other data stores.

In some examples, the datastore 126 can be partitioned into discrete items of data that can be accessed and managed individually (e.g., data shards). Data shards can simplify many technical tasks, such as data retention, unfurling (e.g., detecting that message contents include a link, crawling the link's metadata, and determining a uniform summary of the metadata), and integration settings. In some examples, data shards can be associated with organizations, groups (e.g., workspaces), communication channels, users, or the like.

In some examples, organization data stored in the datastore 126 can include discrete shards for each individual organization, including data related to a particular organization identification. For example, a database shard can store electronic communication data associated with members of a particular organization, which enables members of that particular organization to communicate and exchange data with other members of the same organization in real time or near-real time. In this example, the organization itself can be the owner of the database shard and has control over where and how the related data is stored. In some examples, a database shard can store data related to two or more organizations (e.g., as in a shared channel).

In some examples, individual users can be associated with a database shard within the datastore 126 that stores data related to a particular user account. For example, communication platform user data 132 associated with a particular user account can be stored in a particular database shard. In some examples, third-party user data 134 associated with a particular user account can be associated with a database shard within the datastore 126. The third-party user data 134 can include one or more tokens, access credentials, and/or other data to enable the communication platform to access third-party data 146 associated with a particular user of the communication platform. In some examples, the workflow management component 122 can access the third-party user data 134 to enable one or more third-party workflows to be performed and/or stored in association with the user account. For example, the workflow management component 122 can access credentials associated with a third-party user account stored in the third-party user data 134 to send instructions to a third-party service provider 108 (e.g., via a third-party application 128) to cause the third-party service provider 108 to perform one or more steps associated with a workflow that is integrated into the user account of the communication platform via the interface.

In at least one example, the operating system 124 can manage the processor(s) 112, computer-readable media 114, and/or hardware, software, etc. of the server(s) 102.

The communication interface(s) 116 can include one or more interfaces and hardware components for enabling communication with various other devices (e.g., the user computing device 104, third-party computing device(s) 106, etc.), such as over the network(s) 110 or directly. In some examples, the communication interface(s) 116 can facilitate communication via Websockets, Application Programming Interfaces (APIs) (e.g., using API calls), HyperText Transfer Protocols (HTTPs), etc.

The server(s) 102 can further be equipped with various input/output devices 118 (e.g., I/O devices 118). Such I/O devices 118 can include a display, various user interface controls (e.g., buttons, joystick, keyboard, mouse, touch screen, etc.), audio speakers, connection ports and so forth.

In at least one example, the user computing device 104 can include one or more processors 136, computer-readable media 138, one or more communication interfaces 140, and input/output devices 142.

In at least one example, each processor of the processor(s) 136 can be a single processing unit or multiple processing units, and can include single or multiple computing units or multiple processing cores. The processor(s) 136 can comprise any of the types of processors described above with reference to the processor(s) 112 and can be the same as or different than the processor(s) 112.

The computer-readable media 138 can comprise any of the types of computer-readable media 138 described above with reference to the computer-readable media 114 and can be the same as or different than the computer-readable media 114. Functional components stored in the computer-readable media can optionally include one or more applications 130 and an operating system 144.

The application(s) 130 can include a mobile application, a web application, and/or a desktop application. In some examples, one or more of the application(s) 130 can include third-party applications 128, which can be provided by the third-party service provider(s) 108. In at least one example, at least one application 130 can be provided by the communication platform or which can be an otherwise dedicated application. In some examples, individual user computing devices associated with the system 100 can have an instance or versioned instance of the application(s) 130, which can be downloaded from an application store, accessible via the Internet, or otherwise executable by the processor(s) 136 to perform operations as described herein. That is, the application(s) 130 can be an access point, enabling the user computing device 104 to interact with the server(s) 102 to access and/or use communication services available via the communication platform. In at least one example, the application(s) 130 can facilitate the exchange of data between and among various other user computing devices, for example via the server(s) 102. In at least one example, the application(s) 130 can present user interfaces, as described herein. In at least one example, a user can interact with the user interfaces via touch input, keyboard input, mouse input, spoken input, or any other type of input. In some examples, user interfaces, as described herein, and/or other operations can be performed via a web browser or other access mechanism.

A non-limiting example of a user interface 148 is shown in FIG. 1. As illustrated in FIG. 1, the user interface 148 can present data associated with the communication platform, such as via a communication platform application 130. In various examples, the user interface 148 can be configured to present data associated with one or more communication channels, one or more direct messages and, in some examples, one or more workspaces. That is, in some examples, the user interface 148 can present messages sent via one or more communication channels and/or via direct message(s) in a single user interface so that the user (e.g., of the user computing device 104) can access and/or interact with data associated with the multiple channels and/or direct messaging instances that he or she is associated with and/or otherwise communicate with other users associated with the multiple channels and/or direct messaging instances. The communication channels and/or direct messaging instances can be internal to an organization of the user or externally shared (e.g., include users from two or more organizations, include a first user from a first organization and second user not associated with an organization).

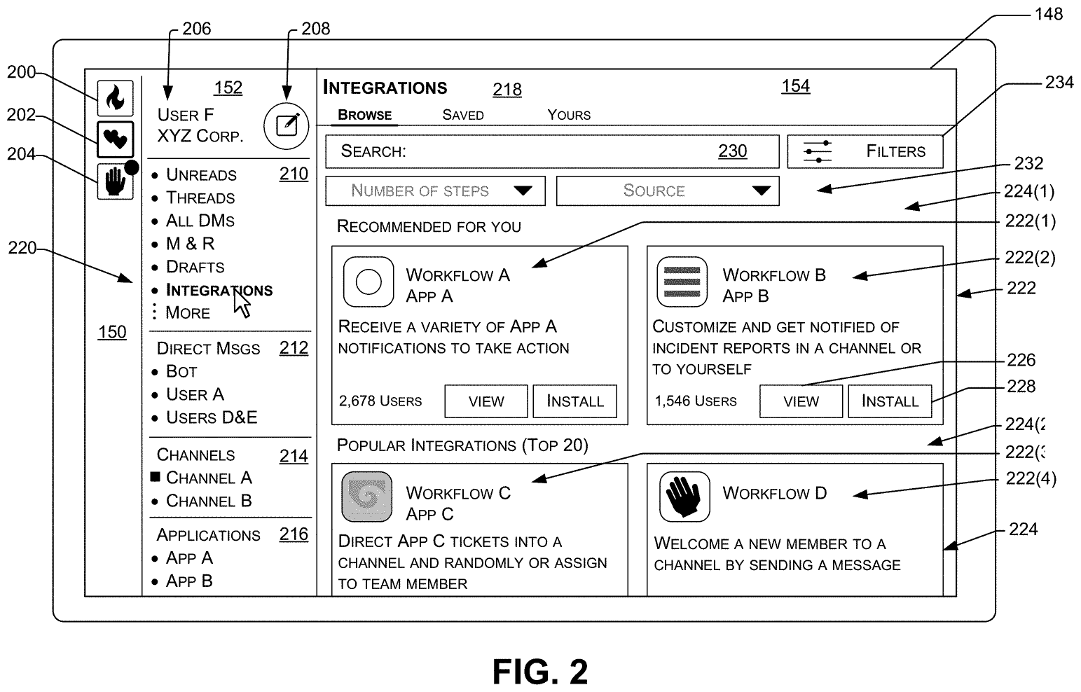

In some examples, the user interface 148 can include a first region 150, or pane, that includes indicator(s) (e.g., user interface element(s) or object(s)) associated with workspace(s) with which the user (e.g., account of the user) is associated. In some examples, the user interface 148 can include a second region 152, or pane, that includes indicator(s) (e.g., user interface element(s) or object(s)) representing data with which the user (e.g., account of the user) is associated. Additional details associated with the second region 152 and indicator(s) are described below with reference to FIG. 2.

In at least one example, the user interface 148 can include a third region 154, or pane, that can be associated with a data feed (or, “feed”) indicating messages posted to and/or actions taken with respect to one or more communication channels and/or other virtual spaces for facilitating communications (e.g., a virtual space associated with direct message communication(s), a virtual space associated with event(s) and/or action(s), etc.) as described herein. In at least one example, data associated with the third region 154 can be associated with the same or different workspaces. That is, in some examples, the third region 154 can present data associated with the same or different workspaces via an integrated feed. In some examples, the data can be organized and/or is sortable by workspace, time (e.g., when associated data is posted or an associated operation is otherwise performed), type of action, communication channel, user, or the like. In some examples, such data can be associated with an indication of which user (e.g., member of the communication channel) posted the message and/or performed an action. In examples where the third region 154 presents data associated with multiple workspaces, at least some data can be associated with an indication of which workspace the data is associated with.

In the illustrative example, the third region 154 includes an integrations interface via which a user of the user computing device 104 can access one or more workflows, as described above. In at least one example, the integrations interface can provide a means by which a user can view data associated with the workflow(s) and/or cause a workflow to be associated with a user account of the user. Additional details associated with the integrations interface are described below with regard to at least FIG. 2.

In at least one example, the operating system 144 can manage the processor(s) 136, computer-readable media 138, hardware, software, etc. of the user computing device 104.

The communication interface(s) 140 can include one or more interfaces and hardware components for enabling communication with various other devices (e.g., the user computing device 104), such as over the network(s) 110 or directly. In some examples, the communication interface(s) 140 can facilitate communication via Websockets, APIs (e.g., using API calls), HTTPs, etc.

The user computing device 104 can further be equipped with various input/output devices 142 (e.g., I/O devices). Such I/O devices 142 can include a display, various user interface controls (e.g., buttons, joystick, keyboard, mouse, touch screen, etc.), audio speakers, connection ports and so forth.

While techniques described herein are described as being performed by the application(s) 130, techniques described herein can be performed by any other component, or combination of components, which can be associated with the server(s) 102, the user computing device 104, or a combination thereof.

FIG. 2 illustrates additional details associated with the user interface 148 that presents data associated with an integrations interface, as described above with reference to FIG. 1.

As described above, in at least one example, the user interface 148 can include a first region 150, or pane, that includes indicator(s) (e.g., user interface element(s) or object(s)) of workspace(s) with which the user (e.g., account of the user) is associated. As illustrated in FIG. 2, the user (e.g., User F) can be associated with three different workspaces. In some examples, the workspaces can be associated with a same organization (e.g., associated with a same organization identifier). In some examples, one or more of the workspaces can be associated with different organizations (e.g., associated with different organization identifiers). In some examples, one of the workspaces can be associated with users from a single organization (e.g., associated with a same organization identifier) and another of the workspaces can be associated with users from two or more different organizations (e.g., associated with different organization identifiers).

In at least one example, each workspace can be associated with a different indicator 200-204, presented via the first region 150. In at least one example, a user account of the user 206 (e.g., User F) can be associated with group identifiers that correspond to each of the workspaces (e.g., as determined by the communication platform user data 132). As such, the user account of the user 206 can be associated with each of the workspaces. A first indicator 200 can represent a first workspace, a second indicator 202 can represent a second workspace, and a third indicator 204 can represent a third workspace.

In some examples, the user 206 can navigate between the workspaces by actuating a control associated with each of the indicators 200-204 without needing to log out of one workspace and log in to each of the other workspaces. Non-limiting examples of such indicators, or any indictors described herein, can include icons, symbols, links, tabs, or other user interface elements or objects. In some examples, such indicators can be associated with actuation mechanisms to enable a user to select an indicator and transition to another workspace. In some examples, a visual indicator can indicate which workspace a user is currently interacting with and/or most recently interacted with. For example, the second indicator 202 is outlined in a heavier weight than the first indicator 200 and the third indicator 204, thereby indicating which workspace the user 206 is currently interacting with and/or most recently interacted with. In some examples, the indicators 200-204 can be associated with another indicator indicating that the corresponding workspace has been updated. An example is shown with respect to the third indicator 204.

While three indicators 200-204 are illustrated in FIG. 2, the user account of the user 206 can be associated with any number of workspaces. In some examples, indicators associated with all of the workspaces with which a user is associated can be presented via the first region 150. In some examples, some of the indicators associated with all of the workspaces with which a user is associated can be presented via the first region 150 and the user can interact with the user interface 148 to view additional or alternative indicators. In examples where fewer than all workspaces are represented via the user interface 148, the indicators can be arranged in alphabetical order, in an order of most recent interaction, in an order based on most frequent interaction, or some other order.

In some examples, the first region 150 may not be included in the user interface 148, and such information can be integrated into the user interface 148 via additional or alternative mechanisms.

In some examples, the user interface 148 can include a second region 152, or pane, that includes indicator(s) (e.g., user interface element(s) or object(s)) representing virtual space(s) associated with the workspace(s) with which the user account of the user 206 is associated. In the illustrative example, the second region 152 can include a compose selectable option 208 that enables the user 206 to compose a message to another user. For purposes of this discussion, a “message” can refer to any electronically generated digital object provided by a user using the user computing device 104 and that is configured for display within a communication channel and/or other virtual space for facilitating communications (e.g., a virtual space associated with direct message communication(s), etc.) as described herein. A message can include any text, image, video, audio, or combination thereof provided by a user (using a user computing device). For instance, the user can provide a message that includes text, as well as an image and a video, within the message as message contents. In such an example, the text, image, and video would comprise the message. Each message sent or posted to a communication channel of the communication platform can include metadata comprising a sending user identifier, a message identifier, message contents, a group identifier, a communication channel identifier, or the like. In at least one example, each of the foregoing identifiers can comprise American Standard Code for Information Interchange (ASCII) text, a pointer, a memory address, or the like.

In at least one example, the second region 152 can include one or more sub-sections, or sub-panes, which can represent different virtual spaces. For example, a first sub-section 210 can include indicators representing virtual spaces that can aggregate data associated with a plurality of communication channels and/or workspaces. In at least one example, each virtual space can be associated with an indicator in the first sub-section 210. In some examples, an indicator can be associated with an actuation mechanism such that when actuated, can cause one of the one or more application(s) 130 (e.g., a communication platform application) to present data associated with the corresponding virtual space via the third region 154. In some examples, a virtual space can be associated with all unread data associated with each of the workspaces with which the user is associated. That is, in some examples, if the user requests to access the virtual space associated with “unreads,” all data that has not been read (e.g., viewed) by the user can be presented in the third region 154, for example in a feed. In such examples, different types of events and/or actions, which can be associated with different communication channels and/or virtual spaces, can be presented via a same feed. In some examples, such data can be organized and/or is sortable by workspace, time, type of action, communication channel, user, or the like. In some examples, such data can be associated with an indication of which user (e.g., member of the communication channel) posted the message and/or performed an action.

In some examples, each virtual space can be associated with a same type of event and/or action. For example, “threads” can be associated with messages, files, etc. posted in threads to messages posted in a communication channel, “All DMs” can be associated with messages, files, etc. posted in direct messaging instances associated with the user account, and “mentions and reactions” (e.g., “M & R”) can be associated with messages or threads where the user 206 has been mentioned (e.g., via a tag) or another user has reacted (e.g., via an emoji, reaction, or the like) to a message or thread posted by the user. That is, in some examples, same types of events and/or actions, which can be associated with different communication channels and/or virtual spaces, can be presented via a same feed. As with the “unreads” virtual space, data associated with such virtual spaces can be organized and/or is sortable by workspace, time, type of action, communication channel, user, or the like.

In at least one example, a virtual space can be associated with integrations that are associated with the user account of the user 206. The integrations can include one or more workflows that are associated with the user account and/or available for association with the user account. A workflow can be available for association with the user account in examples in which the user and/or the user account has associated permissions to install the workflow in association with the user account and/or is associated with the source of the workflow. For example, to associate a workflow provided by a third-party resource with a user account, it may be necessary for the user to establish an account with the third-party resource.

In at least one example, the second region 152 of the user interface 148 can include a second sub-section 212, or sub-pane, that includes include indicators representative of communications with individual users or multiple specified users (e.g., instead of all, or a subset of, members of an organization). Such communications can be referred to as “direct messages.” That is, the second sub-section 212, or sub-pane, can include indicators representative of virtual spaces that are associated with private messages between one or more users (e.g., direct messaging instances).

In addition to the second sub-section 212, the second region 152 can include a third sub-section 214, or sub-pane, that includes indicators representing communication channels. In some examples, the communication channels can include public channels, private channels, shared channels (e.g., between groups or organizations), single workspace channels, cross-workspace channels, combinations of the foregoing, or the like. In some examples, the communication channels represented can be associated with a single workspace. In some examples, the communication channels represented can be associated with different workspaces (e.g., cross-workspace). In at least one example, if a communication channel is cross-workspace (e.g., associated with different workspaces), the user can be associated with both workspaces, or can only be associated with one of the workspaces. In some examples, the communication channels represented can be associated with combinations of communication channels associated with a single workspace and communication channels associated with different workspaces.

In some examples, the third sub-section 214 can depict all communication channels, or a subset of all communication channels, that the user has permission to access (e.g., as determined by the permission data stored in association with communication platform user data 132). In such examples, the communication channels can be arranged alphabetically, based on most recent interaction, based on frequency of interactions, based on communication channel type (e.g., public, private, shared, cross-workspace, etc.), based on workspace, in user-designated sections, or the like. In some examples, the third sub-section 214 can depict all communication channels, or a subset of all communication channels, that the user is a member of, and the user can interact with the user interface 148 to browse or view other communication channels that the user is not a member of but are not currently displayed in the third sub-section 214. In some examples, different types of communication channels (e.g., public, private, shared, cross-workspace, etc.) can be in different sections of the third sub-section 214, or can have their own sub-regions or sub-panes in the user interface 148. In some examples, communication channels associated with different workspaces can be in different sections of the third sub-section 214, or can have their own regions or panes in the user interface 148.

In some examples, the indicators can be associated with graphical elements that visually differentiate types of communication channels. For example, Channel A is associated with a square visual element instead of a circle visual element. As a non-limiting example, and for the purpose of this discussion, the square visual element can indicate that the user is not a current member of Channel A, whereas the circle visual element can indicate that the user is a current member of Channel B. In some examples, additional or alternative graphical elements can be used to differentiate between public communication channels, private communication channels, shared communication channels, communication channels associated with different workspaces, and the like. In other examples, communication channels that the user is not a current member of may not be displayed in the third sub-section 214 of the user interface 148. In such examples, the user can navigate to a different interface (not shown) to browse additional channels that are accessible to the user but to which the user is not currently a member.

In some examples, the second region 152 can include a fourth sub-section 216, or sub-pane, that includes indicators representing applications that are associated with the user account of the user 206. In some examples, the applications can include third-party applications 128, such as those provide by a third-party service provider 108. In some examples, the applications can additionally or alternatively include first party applications, such as those provided by an organization of the user 206 (e.g., XYZ Corp.) and integrated into the communication platform. In the illustrative example, the applications associated with the user account of the user 206 are presented in alphabetical order. However, this is not intended to be so limiting and the applications can additionally or alternatively be presented in an order based on frequency of use, recency of user, an indication of a favorite or “liked” application, or the like. In some examples, one or more applications presented in the fourth sub-section 216 can provide one or more workflows that may be associated with the user account, such as based in part on an association between the user account and the application (e.g., the user maintains an account with the application provider, associates the application with the user account, etc.).

As described above, in at least one example, the user interface 148 can include a third region 154, or pane, for presenting data associated with the communication platform, such as data associated with one or more communication channels, direct messaging instances, workspaces, and/or one or more external connections. In at least one example, the third region 154 can present data that is associated with a feed indicating messages posted to and/or actions taken with respect to a communication channel and/or other virtual space (e.g., a virtual space associated with direct message communication(s), a virtual space associated with event(s) and/or action(s), etc.) for facilitating communications. As described above, in at least one example, data associated with the third region 154 can be associated with an integrations interface 218. That is, in some examples, the third region 154 can present data associated with connecting to and/or viewing current connections (e.g., direct messaging instances and/or communication channels) that include at least one user from another organization (e.g., organization that is different from an organization of the user) and/or an individual account that is not associated with an organization.

For example, in FIG. 2, the user 206 can interact with the user interface 148 to view data associated with the integrations interface 218. In some examples, the user 206 can access the integrations interface 218 by selecting an integrations indicator 220, such as that illustrated in the first sub-section 210. In response to receiving an indication of selection of the integrations indicator 220, the communication platform can cause the integrations interface 218 to be presented via the third region 154. In some examples, the integrations interface 218 can provide a means by which the user 206 can access data associated with one or more workflows 222 that are available for association with the user account.

In various examples, the workflow(s) 222 (representation thereof) can be available for association with the user account based on permissions associated with the user account and/or workflow, user preferences and/or organization preferences with regard to workflows. The permissions can be associated with a type of communication platform account associated with the user (e.g., limited use, paid account full access account, enhanced account, etc.), a type of third-party resource account associated with the user, a job position or title associated with the user (e.g., workflow associated with managers, C-suite executives, etc.), a type of job associated with the user (e.g., teachers, health care professionals, etc.), and/or the like. For example, a workflow provided by the communication platform may be available to users with a full access and/or paid communication platform account, but users with limited use accounts may not have access privileges to view and/or associate the workflow with their account. For another example, the communication platform can provide a particular workflow that is associated with health care professionals. The communication platform may grant permissions for user accounts that have an association with health care to view data and/or associate the particular workflow with their accounts.

In some examples, the workflow(s) 222 (representation thereof) can be available for display based on one or more user preference and or organization preferences, such as those stored in user data 132 of the user 206. In some examples, the user and/or organization (e.g., administrative user of an organization) can establish one or more preferences with regard to workflow(s) 222 presented via the integrations interface 218. Based on the user and/or organization preferences, the communication platform (e.g., workflow management component 122) can identify the workflow(s) 222 to be presented via the integrations interface 218. For example, an administrator of an organization can select a group of workflows from a plurality of workflows provided by the communication platform and/or third-party resources that may be integrated into user accounts that are associated with the organization, such as to establish common workflows across an organization (e.g., approved business processes). The communication platform can identify that the user account is associated with the organization and, based on the selection of a preference (or requirement, limitation, etc.) for user accounts associated with the organization to use the selected group of workflows, can cause a presentation of the selected group of workflows via the integrations interface 218.

As discussed above, the communication platform (e.g., workflow management component 122) can identify workflow(s) 222 to present via the integrations interface 218 based on characteristics associated with the user account. In such examples, the communication platform can be configured to present workflow(s) 222 that are relevant to the user. The characteristics can include an organization identifier associated with an organization of the user, a group or team identifier, a type of user account (e.g., paid, unpaid, temporary, permanent, etc.), employment data (e.g., job position, title, team affiliation, project affiliation, employment location, etc.), qualification (e.g., education, certifications, etc.), third-party application integration (e.g., integration stored in association with user account), user interests (e.g., personal interests, work-related interests, etc.), demographic data (e.g., age, home location, etc.), interaction data (e.g., frequency and/or recency of interactions with other users, with virtual spaces (e.g., communication channels, direct messaging instances, boards, audio and/or video conversations, etc.), and/or other characteristics of the user account.

In some examples, the communication platform can cause a presentation of different workflows 222 in different sections. The sections can include different categories of workflows 222. For example, a first section 224(1) can include workflows that are recommended for the user 206, such as based on characteristics of the user, and a second section 224(2) can include workflows that are popular across the communication platform or a portion thereof. Though this is not intended to be so limiting and the integrations interface 218 can include a greater or lesser number of sections 224 that are associated with additional or alternative categories (e.g., fun and games integrations, popular with people like you, etc.). As shown in FIG. 2, the first section 224(1) includes a first workflow 222(1) and a second workflow 222(2), and the second section 224(2) includes a third workflow 222(3) and a fourth workflow 222(4), though this is merely for illustrative purposes and each section can include a greater or lesser number of workflows 222. For example, the first section 224(1) and the second section 224(2) can each include a presentation of a plurality of workflows 222 that are scrollable horizontally (e.g., left to right or right to left) and/or vertically.

As described above, the communication platform can identify the workflows 222 to present to the user 206 via the integrations interface 218 based on user characteristics of the user, similarity with other users, popular integrations across the communication platform and/or with similar users, workflows 222 associated with applications (e.g., third-party application(s) 128, first-party application associated with XYZ Corp., etc.) with which the user account of the user 206 is associated (e.g., installed applications in association with the user account and/or client of the user 206), and the like. For example, the communication platform identifies the first workflow 222(1) that is associated with Application A and the second workflow 222(2) that is associated with Application B, to recommend for the user. As a non-limiting example, an application can be associated with a workflow based on at least one of the steps of a series of steps associated with a task of the workflow being performed by an entity that manages and/or provides the application (e.g., third-party resource, organization associated with a first-party application, etc.). For another example, the communication platform identifies the third workflow 222(3) associated with Application C and a fourth workflow 222(4) that is provided by the communication platform, as popular integrations across the communication platform and/or a portion thereof.

In some examples, a workflow 222 can be popular based on a total number of user accounts that have associated with the workflow 222. In such examples, the communication platform can identify the top ranked workflows based on the one or more workflows that have been integrated into the most user accounts across the communication platform or a portion thereof. In some examples, the communication platform identifies the most popular (e.g., highest number of integrations) based on account similarity to the user account of the user 206, such as based on similar characteristics between the user accounts and other user accounts of the user. In such examples, the communication platform can cause a presentation of popular workflows 222 among other users who are similar to the user 206. In the illustrative example, the communication platform causes a presentation of the “top 20” highest ranked or most popular workflows (e.g., integrations). Though this is merely included for illustrative purposes and the communication platform can be configured to cause a presentation of any number of popular workflows 222.

In various examples, each workflow 222 presented via the integrations interface 218 can include a name and/or a description associated with the respective workflow 222. In some examples, as described above, one or more of the workflows 222 can additionally include a source (e.g., primary provider) of the workflow. In some examples, the absence of an indication of a source, such as that presented in association with the fourth workflow 222(4), can indicate that the communication platform is the source of the workflow 222(4).

Additionally, in some examples, each workflow 222 can include a view selectable control 226 and/or an install selectable control 228. In response to receiving an indication of selection of the view selectable control 226, the communication platform can cause a presentation of additional details associated with a respective workflow 222. As will be discussed in greater detail below with respect to FIGS. 4A-6B, the additional details can include implementation details, information associated with entities performing each step in a series of steps (e.g., information associated with how the workflow is performed), triggering actions to cause the workflow to be initiated, one or more workflows that are related to the selected workflow, and the like.

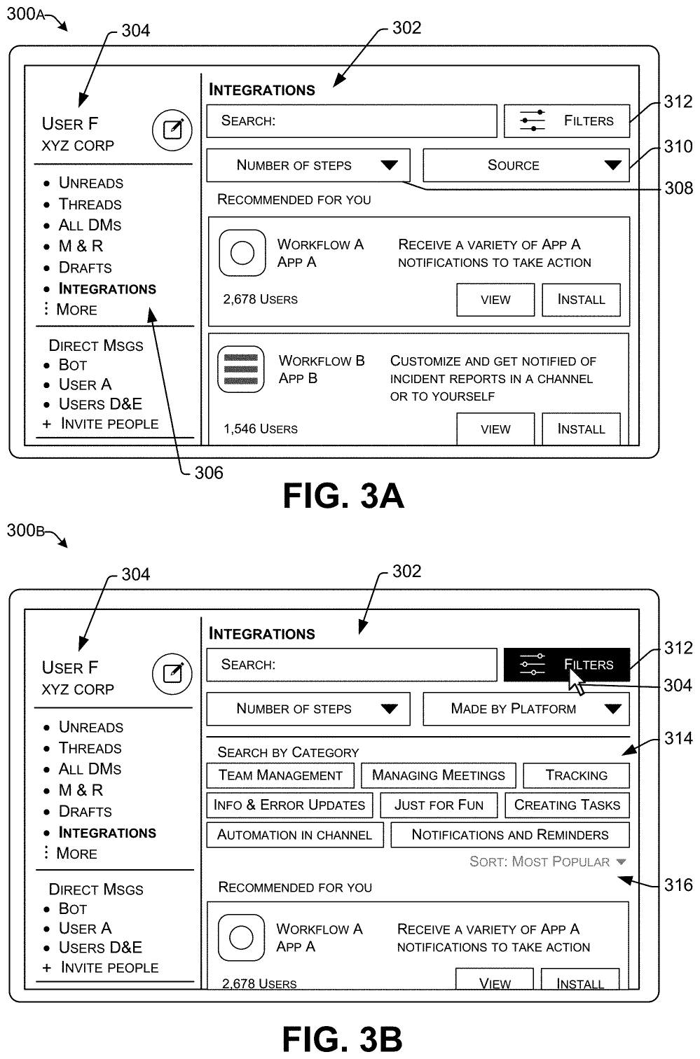

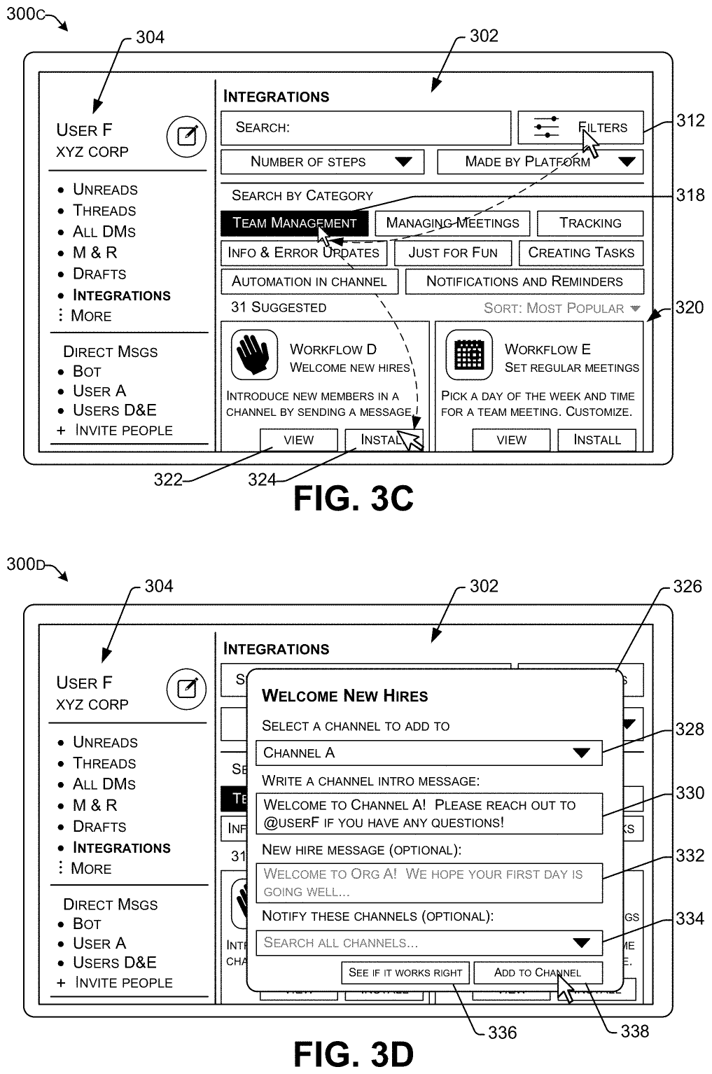

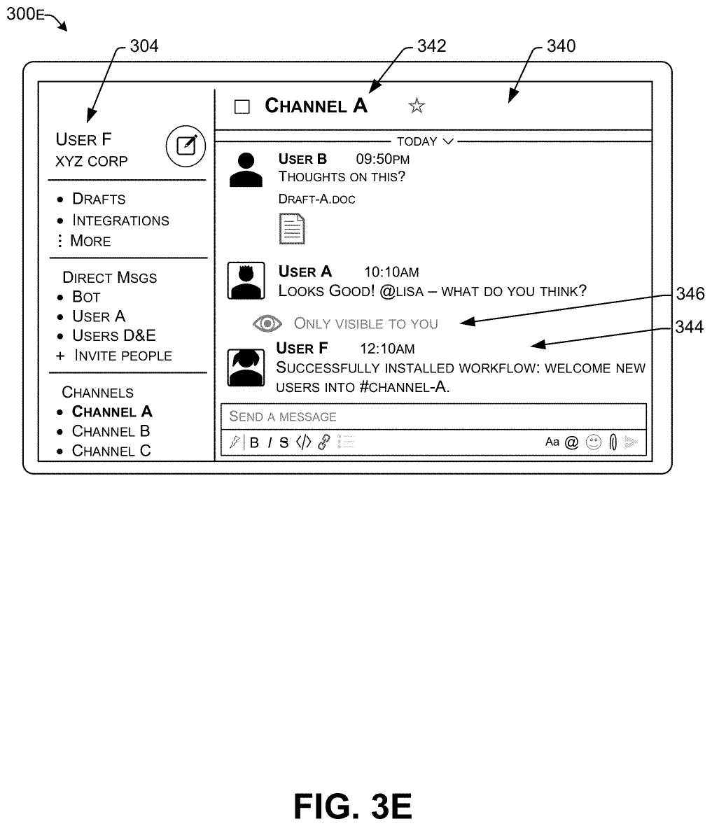

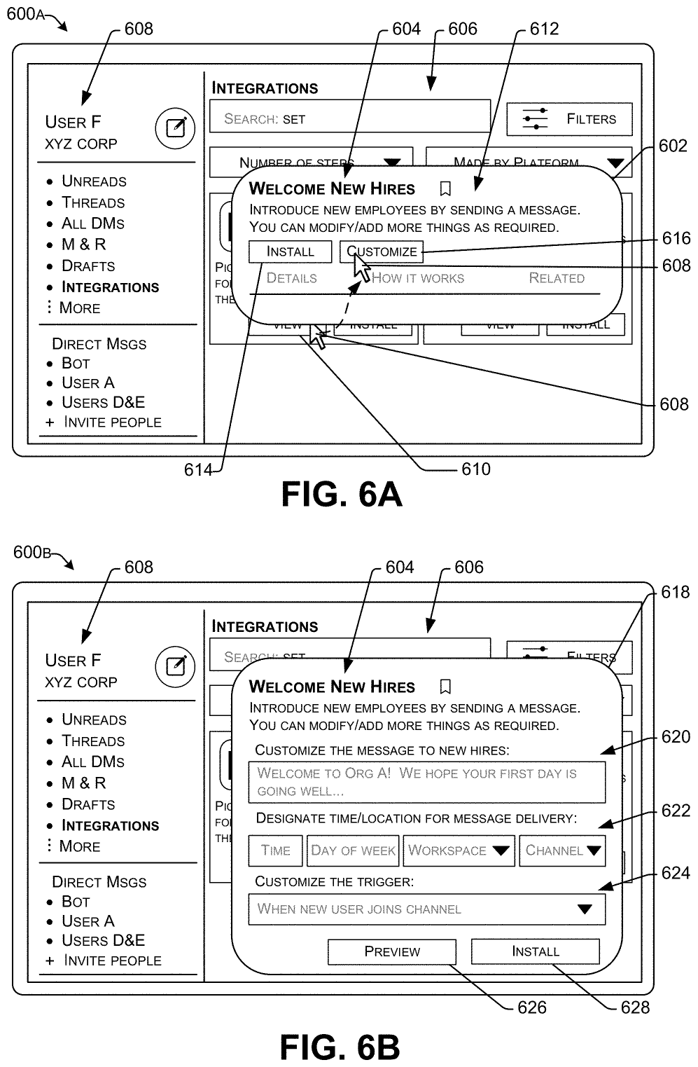

In response to receiving an indication of selection of the install selectable control 228, the communication platform can cause the selected workflow to be associated with the user account of the user 206. As will be discussed in greater detail below with respect to FIGS. 3A-3E and FIGS. 6A and 6B, in response to receiving the indication of selection of the install selectable control 228, the communication platform can cause a presentation of a customization window via the integrations interface 218, such as to enable the user 206 to customize the selected workflow.

In various examples, additional or alternative data can be presented via the third region 154 of the user interface 148. For example, non-limiting examples of additional data that can be presented via the third region 154 include a collection of workflows 222 previously associated with the user account of the user 206 (e.g., accessible via the “yours” indicator), one or more workflows 222 that have been saved by the user 206 (e.g., accessible via the “saved” indicator), a feed associated with one or more communication channels and/or one or more direct messaging instances, and/or other data available for presentation by the communication platform and/or a third-party resource via the communication platform.

In at least one example, the integrations interface 218 can include a search mechanism 230, wherein a user can input a search term and the communication platform can perform a search for a particular workflow 222. In some examples, the integrations interface 218 can additionally include one or more filtering options 232. In the illustrative example, the filtering options 232 can include a number of steps and a source (e.g., made by platform, provided by third-party resource, provided by XYZ Corp, etc.) associated with workflow(s) to be presented via the integrations interface 218. In some examples, the integrations interface 218 can also include a filter selectable control 234 that enables access to additional filtering mechanisms to assist the user 206 in identifying a workflow to associate with the user account. Additional details of the filter selectable control will be described below with regard to FIGS. 3A-3C.

The user interface 148 is a non-limiting example of a user interface that can be presented via the user computing device 104 (e.g., by one of the one or more applications 130). In some examples, the application 130 can receive data from the messaging component 120, the workflow management component 122, and/or a third-party computing device(s) 106 (e.g., third-party application 128, third-party data 146, etc.), and can generate and present the user interface 148 based on the data. In other examples, the application 130 can receive the data and instructions for generating the user interface 148 from the messaging component 120 and/or workflow management component 122. In such an example, the application 130 can present the user interface 148 based on the instructions. Additional or alternative data can be presented via a user interface and additional or alternative configurations can be imagined.

FIG. 3A-FIG. 6B are schematic views showing example user interfaces that are usable to implement the techniques described herein for enabling access to data associated with a plurality of workflows. The interfaces can be generated by a computing device of a communication platform (e.g., server(s) 102) and transmitted to one or more user computing devices (e.g., user computing device(s) 104) for presentation. Additionally or alternatively, the interfaces can be generated by the user computing device(s) based at least in part on instructions received from the communication platform. The interfaces illustrated in FIGS. 3A-6B may, but need not, be implemented in the context of the system 100.

FIGS. 3A-3E illustrate an example user interface for enabling access to one or more workflows for incorporation into a user account, as described herein. The interfaces 300A, 300B, 300C, 300D, and/or 300E can be associated with a user computing device, such as user computing device 104. Interface 300A of FIG. 3A illustrates an integrations interface 302, such as integrations interface 218, which can be presented in response to an indication of selection, by a user 304, of an integrations indicator 306, such as integrations indicator 220.

As discussed above, the integrations interface 302 can include one or more filtering options, such as filtering options 232, that are built into (e.g., consistently presented) the integrations interface 302, such as a first filtering option 308 and a second filtering option 310. In the example of FIG. 3A, the first filtering option 308 can enable the user to filter a number of steps associated with workflows presented via the integrations interface 302, and the second filtering option 310 can enable the user to filter the workflows by source. Though this is merely an illustrative example, and any other type and/or number of filtering options can be presented via the integrations interface 302. For example, the integrations interface may not include any filtering options, and instead, may provide the filtering options via a filter selectable control 312, such as filter selectable control 234.

In some examples, the filter selectable control 312, can provide one or more filtering options for the user 304 to limit a number and/or type of workflow (e.g., category of workflow) that is presented via the integrations interface 302. In response to receiving an indication of selection of the filter selectable control 312, the communication platform can cause additional filtering options to be presented via the integrations interface 302.

Interface 300B of FIG. 3B illustrates the integrations interface 302 with the additional filtering options 314 presented. As non-limiting examples, the additional filtering options 314 can include options to filter workflows based on an association with team management, managing meetings, tracking statistics and/or other metrics, information and error updates, fun and/or games, creating tasks, generating and/or managing automations in a communication channel or other virtual space, setting notifications and reminders (e.g., for the user 304 to perform an action), personal workflows (e.g., associated with personal or non-work related tasks), and/or the like.

Additionally, in some examples, the integrations interface 302 can include a sorting control 316, such as to enable the user 304 to sort through identified workflows. The sorting control 316 can include options to sort by most popular workflows, most recently integrated, most frequently integrated by users of an organization, and/or other sorting controls. In such examples, the sorting can render the collection of workflows more manageable for the user 304, thereby improving a user experience with the integrations interface 302. In various examples, in response to receiving an indication of selection of an additional filtering option 314 and/or a sorting option provided via the sorting control 316, the communication platform can identify one or more workflows that are relevant to the filtering (e.g., filtered workflows).

Interface 300C of FIG. 3C illustrates the integrations interface 302 in which the user 304 selects a team management filtering option 318 of the additional filtering options 314, such as to cause a filtered collection of workflows 320 to be presented via the integrations interface 302. As discussed above, in response to receiving an indication of selection of the filter selectable control 312, the communication platform can cause additional filtering options 314 to be presented via the integrations interface 302. In response to receiving an indication of selection of one or more filtering options 314, the communication platform can filter the workflows that are available for association with the user account of the user 304 based on associated filtering criteria (e.g., at least one filtering criterion). For example, in response to receiving an indication of selection of the team management filtering option 318, the communication platform causes the filtered collection of workflows 320 to be presented via the integrations interface, the filtered collection of workflows 320 including one or more workflows that are associated with team management tasks and/or functions. Though illustrated in FIG. 3C as a user 304 selection of a single filtering option (e.g., team management filtering option 318), this is not intended to be so limiting, and the integrations interface 302 can be configured to enable the user 304 to select two or more filtering options, such as to further narrow a search for relevant workflows.

In the illustrative example, the filtered collection of workflows 320 includes 31 workflows (e.g., 31 suggested), though a greater or lesser number of workflows can be presented in response to receiving the filtering criteria associated with one or more filtering options. In various examples, the integrations interface 302 can enable the user to scroll through the filtered collection of workflows 320, to identify a particular workflow to associate with the user account. In various examples, each workflow can include a view selectable control 322, such as view selectable control 226, configured to enable the user 304 to view additional details about the workflow. In some examples, each workflow can include an install selectable control 324, such as install selectable control 228, configured to enable the user 304 to associate a selected workflow with the user account of the user 304. For example, in response to an indication of selection of an install selectable control 324 associated with Workflow D, the communication platform can associate the selected workflow (e.g., Workflow D) with the user account of the user 304. In various examples, in response to receiving an indication of selection of the install selectable control 324, the communication platform can cause a customization window to be presented in association with the integrations interface 302. In such examples, the customization window can enable the user to customize a selected workflow.

Interface 300D of FIG. 3D illustrates the integrations interface 302 with an associated customization window 326. As discussed above, in some examples, the communications platform can enable the user to customize a selected workflow (e.g., Workflow D). In such examples, in response to receiving an indication of selection of the selected workflow, the communication platform can cause a presentation of the customization window 326, via which the user can input one or more customizations to be associated with the selected workflow.

In various examples, the customization(s) provided in the customization window 326 can be associated with the selected workflow. In such examples, the communication platform can identify the customization(s) to include in the customization window 326 based on an identification of the selected workflow. In FIG. 3D, the customization(s) presented in the customization window 326 include a channel input box 328, a channel intro message 330, a new hire intro message input box 332, and a channel notification option 334, though this is merely an illustrative example, and additional or alternative customization(s) can be presented in the customization window 326, such as an input control associated with inputting a customized name for the workflow, a time or day associated with the workflow, a triggering action associated with the workflow, an association of the workflow with a shortcut of a shortcut menu, and/or the like.

In various examples, the channel input box 328 can include a means by which the user 304 can associate a particular communication channel with the selected workflow. That is, a task associated with the selected workflow can be performed in association with the particular communication channel. In some examples, the channel input box 328 can enable the user to select two or more communication channels for association with the selected workflow. In additional or alternative examples, the customization window 326 can include a virtual space input box to enable the user to associate the selected workflow across one or more communication channels, one or more boards, one or more workspaces, one or more boards, and/or other virtual spaces (e.g., audio and/or video conversations, etc.).

In some examples, the channel intro message 330 can enable the user 304 to personalize a message to new users who associate with the selected channel (e.g., Channel A). Though described, for illustrative purposes as an introduction message to a channel, the introduction message can additionally or alternatively be a message of introduction to a workspace, a board, an audio or video conversation group, or the like. Additionally, in the illustrative example, the selected workflow can include an option to welcome newly hired employees. As such, the customization window 326 can provide a means by which the user 304 can customize a message to be presented to the newly hired employees in association with the selected workflow (e.g., selected workflow includes a task to welcome new hires). In various examples, the customization window 326 can additionally provide a means by which the user 304 can select one or more communication channels (or other virtual spaces) to receive a notification of the new hire (e.g., notification that the newly hired employee has joined). In such examples, the user 304 can include an additional task of providing the notification in association with the selected workflow, to enable other users to welcome the newly hired employee.

In various examples, the customization window 326 can include a preview selectable control 336 (illustrated as “see if it works right”) configured to enable the user 304 to preview a result of the customized workflow. In response to receiving an indication of selection of the preview selectable control 336, the communication platform can cause a presentation of a preview of the task being completed. For example, the in response to receiving an indication of selection of the preview selectable control 336, the communication platform can cause a presentation of the selected channel (e.g., Channel A) with an example message directed to an example new hire. Based on a determination that the user 304 input data into the new hire intro message input box 332, and/or the channel notification option 334, the communication platform can cause a presentation of an example new hire message and/or an example notification via the integrations interface 302.

In some examples, the customization window 326 can include an add customization selectable control 338 configured to enable the user 304 to add the customization to the selected workflow stored in association with the user account. In some examples, the add customization selectable control 338 can be configured to associate the customized workflow with one or more selected channels and/or other virtual spaces. Similar to the description above, though illustrated as an option to “add to channel,” the add customization selectable control 338 is not intended to be so limiting and can include options to add to a selected workspace, board, audio and/or video conversation, and/or any other type of virtual space provided by the communication platform.

Interface 300E of FIG. 3E illustrates an example messaging interface 340 associated with a virtual space 342 (illustrated as channel A) selected via the customization window 326 of FIG. 3D. As discussed above, the communication platform can associate a selected workflow (e.g., Workflow D) with a selected virtual space 342 based in input provided via the customization window 326 and in response to receiving an indication of selection of the add customization selectable control 338.

In various examples, the communication platform may generate an automated message 344 associated with the selected workflow. For example, the automated message 344 can provide an indication that the user 304 successfully installed the selected workflow into the selected virtual space 342. In some examples, the automated message 344 can be published via the virtual space 342, such that it is visible to the members of the virtual space 342. In various examples, the automated message 344 can be presented to the user 304, and withheld from view to other members of the virtual space 342. In some examples, the messaging interface 340 can provide a limited visibility indication 346 in association with the automated message 344. For example, the limited visibility indication 346 can include an indication that the associated message is “only visible to you” (e.g., user 304).

In the illustrative example, the automated message 344 includes an indication that the communication was generated and transmitted by the user 304. Similarly, other automated messages associated with the selected workflow (e.g., Workflow D to welcome new users) that are generated and transmitted by the communication platform (e.g., source of the selected workflow) can include the indication that the communication was generated and transmitted by the user 304. That is, the selected workflow can cause the communication platform to automatically generate and cause a presentation of messages to other users (e.g., new users), from the user 304, based on a triggering action (e.g., users join the virtual space 342, new user is hired and associates with the communication platform and/or the virtual space 342, etc.).

FIGS. 4A and 4B illustrate example user interfaces for providing detailed information associated with a workflow, as described herein. Interface 400A of FIG. 4A includes an integrations interface 402, such as integrations interface 218, and/or integrations interface 302, presented in association with a user account of a user 404, such as user 206 and/or user 304.

As discussed above, the integrations interface 402 can include a search mechanism 406, such as search mechanism 230, such as to enable the user 404 to narrow a focus of a search to a particular topic or function. The search mechanism 406 can be configured to receive input 408 from the user 404. In response to the input 408, the communication platform can identify one or more relevant workflows 410. For example, the input 408 includes the word “set.” In response to receiving the input 408 (e.g., the word “set”), the communication platform identifies relevant workflow(s) 410 that include the word set in a description, such as a first workflow 410(1) (e.g., Workflow F) and a second workflow 410(2) (e.g., Workflow G).

In various examples, the relevant workflow(s) 410 can include details associated with the workflow, such as a name and description. In some examples, the relevant workflow(s) 410 can include view selectable control 412, such as view selectable control 226, to enable the user 404 to view additional details associated with the workflow 410. The additional details can include implementation details, information associated with entities performing each step in a series of steps (e.g., information associated with how the workflow is performed), triggering actions to cause the workflow to be initiated, one or more workflows that are related to the selected workflow, and the like. For example, in response to receiving an indication of selection of the view selectable control 412 associated with the first workflow 410(1), the communication platform can cause a presentation of additional details associated with the first workflow 410(1).

Interface 400B of FIG. 4B illustrates the integrations interface 402 including a details window 414 with a details page 416 associated with the selected workflow (e.g., the first workflow 410(1)). In some examples, the details page 416 can be presented automatically (e.g., default page) in response to an indication of selection of the view selectable control 412. In some examples, the details page 416 can be presented via the details window 414 in response to an indication of selection of a details selectable control 418 associated with the details window 414.

In various examples, the details page 416 can include a portion of the additional details associated with the selected workflow, as stored in association with and identified by the communication platform. In the illustrative example, the portion of the additional details includes a detailed explanation of the selected workflow, a source of the selected workflow (e.g., the communication platform), and a number of users who have associated the selected workflow with a respective user account, though this is not intended to be so limiting and additional or alternative details associated with the selected workflow are contemplated herein.

Additionally, in some examples, the details window 414 can include a function selectable control 420 and/or a related workflows selectable control 422. The function selectable control 420 can be configured to provide a means by which the user 404 can view implementation details associated with the selected workflow (e.g., how it works). Additional information about the function selectable control 420 are discussed below with regard to FIG. 5B. The related workflows selectable control 422 can be configured to provide a means by which the user 404 can view one or more other workflows that are related to the selected workflow (e.g., related workflow(s)). Additional information about the related workflows selectable control 422 are discussed below with regard to FIG. 5C.

FIGS. 5A-5C illustrate example user interfaces for providing a details regarding the functionality of a workflow, as described herein. Interface 500A of FIG. 5A illustrates a details window 502 (e.g., details window 414) associated with a selected workflow 504 (e.g., welcome new hires) that is presented in association with an integrations interface 506, such as integrations interface 218, 302, and/or 402. As discussed above, the details window 502 may be presented in association with the integrations interface 506 responsive to receiving an indication of selection, by a user 508 (e.g., user 206, 304, and/or 404), of a view selectable control associated with the selected workflow 504, such as view selectable control 226 and 412.

As shown in FIG. 5A, the details window 502 can include a details page 510, such as details page 416, including a portion of the additional details associated with the selected workflow 504, as stored in association with and identified by the communication platform. In the illustrative example, the portion of the additional details includes a detailed description 512, a triggering action 514, and customization options 516 associated with the selected workflow 504. Though this is not intended to be limiting, and the details page 510 can include additional or alternative data associated with the selected workflow 504, such as include a source of the selected workflow 504 (e.g., the communication platform, third-party application, first party application, etc.), a number of users who have associated the selected workflow with a respective user account, a degree of popularity (e.g., among top 100 workflow, 5^{th} most popular workflow, etc.), and the like.

In some examples, the details page 510 can be presented automatically (e.g., default page) in response to an indication of selection the view selectable control associated with the selected workflow 504. In some examples, the details page 510 can be presented via the details window 502 in response to an indication of selection of a details selectable control 518, such as details selectable control 418.

As illustrated, the details window 502 can additionally include a function selectable control 520, such as function selectable control 420, configured to provide a means by which the user 508 can view implementation details associated with the selected workflow 504 (e.g., how it works). For example, in response to receiving an indication of selection of the function selectable control 520, the communication platform can cause a function page to be presented via the details window 502.

Interface 500B of FIG. 5B illustrates a function page 522 including implementation details associated with the selected workflow 504. In various examples, the function page 522 can be presented automatically (e.g., default page) in the details window 502 in response to an indication of selection a view selectable control associated with the selected workflow 504. In some examples, the function page 522 can be presented in the details window 502 in response to an indication of selection of a function selectable control 520.

In the illustrative example, the function page 522 includes a process flow 524 including information associated with each step in performing a task associated with the selected workflow (e.g., steps in the workflow). For example, the process flow 524 can include a triggering action, or an action that initiates the workflow, a response to the triggering action (e.g., shortcut associated with the workflow is selected, new user joins channel, new employee joins organization, etc.), and a resulting action (e.g., send a message, present a notification, etc.). Though this is merely an illustrative example involving generating and sending a message and it is not intended to be so limiting.

Additionally, the function page 522 can include a preview 526 of information associated with the process flow 524. For example, the preview 526 can include an illustration of a new member joining a particular channel associated with the process flow 524 (e.g., triggering action). For another example, the preview 526 can include an illustration of a message generated and transmitted to a user account of the new user (e.g., resulting action). Though illustrated as including a single preview associated with the triggering action, this is not intended to be so limiting, and the preview 526 can include additional or alternative previews, such as in response to the user scrolling through the function page to view additional details associated with the process flow 524 and/or the preview 526.

As illustrated, the details window 502 can additionally include a related workflows selectable control 528, such as related workflows selectable control 422. The related workflows selectable control 528 can be configured to provide a means by which the user 508 can view one or more other workflows that are related to the selected workflow (e.g., related workflow(s)). For example, in response to receiving an indication of selection of the related workflows selectable control 528, the communication platform can cause a related workflows page to be presented in the details window 502.

Interface 500C of FIG. 5C illustrates a related workflows page 530 including one or more related workflows associated with the selected workflow 504. In the example of FIG. 5C, the related workflows page 530 includes a first related workflow 532 and a second related workflow 534, though this is just for illustrative purposes and a greater or lesser number of related workflows may be presented via related workflows page 530.

In various examples, the related workflows page 530 can be presented automatically (e.g., default page) in the details window 502 in response to an indication of selection a view selectable control associated with the selected workflow 504. In some examples, the communication platform can cause a presentation of the related workflows page 530 in response to receiving an indication of selection of the related workflows selectable control 528.

In various examples, the communication platform can be configured to identify the one or more other workflows that are related to the selected workflow 504. The related workflow(s) (e.g., first related workflow 532, the second related workflow 534, etc.) can include other workflows that may supplement and/or augment the selected workflow. For example, the related workflow(s) can include workflows that can be applied prior to the selected workflow, concurrently with the selected workflow, or after the selected workflow, such as to enhance a user experience and overall functionality of the communication platform with respect to a user account.

As illustrated, the communication platform can provide a name and a brief explanation associated with each related workflow. In some examples, the communication platform can provide details associated with how the related workflow augments or supplements and/or is related to the selected workflow 504. In various examples, the communication platform can provide a separate installation selectable control 536 in association with related workflows, such as the first related workflow 532. In various examples, the separate installation selectable control 536 can enable the user 508 to associate the first related workflow 532 with the user account separately and apart from the selected workflow 504. In such examples, the selected workflow 504 and the first related workflow are stored and implemented separately in association with the user account.

In various examples, the communication platform can provide a combine selectable control 538 in association with the related workflows, such as the first related workflow 532. In various examples, the combine selectable control 528 can enable the user 508 to associate the first related workflow 532 with the selected workflow 504 in association with the user account. That is, the first related workflow 532 can be combined with the selected workflow 504, such that the two workflows are performed as one, either concurrently or consecutively. In various examples, the communication platform can determine an order in which the first related workflow 532 and the selected workflow 504 are performed based in part on implementation details associated with each workflow. For example, the selected workflow 504 can include a triggering action for the first related workflow 532, such that at the completion of the selected workflow 504, the first related workflow is initiated.

FIGS. 6A and 6B illustrate example user interfaces for customizing a workflow, as described herein. Interface 600A of FIG. 6A illustrates a details window 602 (e.g., details window 414, 502, etc.) associated with a selected workflow 604 (e.g., welcome new hires) that is presented in association with an integrations interface 606, such as integrations interface 218, 302, 402, and/or 506. As discussed above, the details window 602 may be presented in association with the integrations interface 606 responsive to receiving an indication of selection, by a user 608, such as user 206, 304, and/or 404, of a view selectable control 610 (e.g., view selectable control.

In the illustrative example, the communication platform causes a presentation of a default description of the selected workflow 604. The default page 612 also includes a details selectable control (e.g., details selectable control 418, 518, etc.), a function selectable control (e.g., function selectable control 520), and a related workflows selectable control (e.g., related workflows selectable control 528), details of each of which are described above with regard to FIGS. 5A-5C.

In various examples, the details window 602 can include an install selectable control 614. As discussed above, in response to receiving an indication of selection of the install selectable control 614, such as install selectable control 228 and install selectable control 324, the communication platform can associate the selected workflow 604 with a user account of the user. In various examples, the details window 602 can include a customization selectable control 616, such as customization selectable control 338, configured to enable the user 608 to customize the selected workflow 604. In various examples, in response to receiving an indication of selection of the customization selectable control 616, the communication platform can cause a customization window to be presented in association with the integrations interface 606.

Interface 600B of FIG. 6B illustrates a customization window 618 presented in association with the integrations interface 606, such as in response to receiving an indication of selection of the customization selectable control 616. In the illustrative example, the customization window 618 includes a first customization option 620 to customize a message associated with the selected workflow 604, a second customization option 622 to designate a time and/or location (e.g., direct messaging instance, a channel, a workspace, etc.) for message delivery, and a third customization option 624 to customize a triggering action associated with the workflow (e.g., action that initiates the workflow). Though this is not intended to be so limiting and additional or alternative customizations are contemplated herein.

In various examples, each of the first customization option 620, the second customization option 622, and the third customization option 624 can include input controls configured to receive input from a user 608. In some examples, the input controls can include drop down menus, enabling the user 608 to select available options for particular customizations via the drop down menus. In some examples, the input controls can include areas configured to receive input that is typed and/or spoken. In such examples, the communication platform can be configured to identify the input and desired customization, such as utilizing natural language processing or the like.

In various examples, the customization window 618 can include a preview selectable control 626 to enable the user 608 to view a preview of the customized workflow, such as preview 526. The customization window 618 can additionally include an install selectable control 628, such as install selectable control 614, that, when selected, causes the communication platform to associate the customized workflow with the user account of the user.

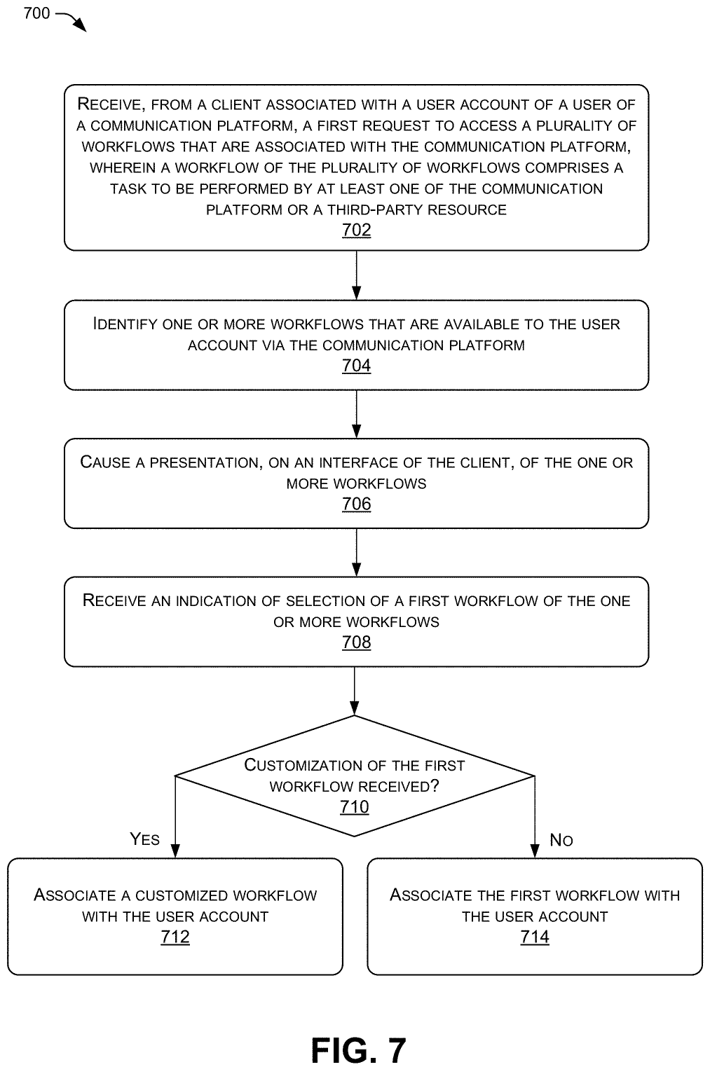

FIGS. 7-9 are flowcharts showing example processes involving techniques as described herein. The processes illustrated in FIGS. 7-9 are described with reference to components described above with reference to the system 100 shown in FIG. 1 for convenience and ease of understanding. However, the processes illustrated in FIGS. 7-9 are not limited to being performed using the components described above with reference to the system 100. Moreover, the components described above with reference to the system 100 are not limited to performing the processes illustrated in FIGS. 7-9.

FIG. 7 illustrates an example process 700 for associating a workflow with a user account, as described herein. In some instances, some or all of process 700 can be performed by one or more components in the system 100. By way of example and not limitation, the communication platform referred to in process 700 can be representative of a computing device associated with the (communication platform) server(s) 102, a client referred to in process 700 can be representative of the user computing device(s) 104 and/or application 130. However, the process 700 is not limited to being performed by the system 100.

At operation 702, the communication platform receives, from a client associated with a user account of a user of a communication platform, a first request to access a plurality of workflows that are associated with the communication platform, wherein a workflow of the plurality of workflows comprises a task to be performed by at least one of the communication platform or a third-party resource. In various examples, the first request can include an indication of selection of an integrations indicator, such as integrations indicator 220 and integrations indicator 306. In various examples, the first request can be submitted via a different indicator associated with the plurality of workflows provided via the communication platform.

As discussed above, each workflow of the plurality of workflows can be associated with a task (e.g., series of steps) completed to accomplish a particular outcome (e.g., a desired outcome). For example, a workflow can include a task to send a welcome message to new members of a particular communication channel. In response to receiving an indication that a new member has joined the particular channel (e.g., triggering action or trigger), the communication platform can generate and transmit a welcome message to at least the new member via a messaging interface in association with the particular channel. The task can be completed by the communication platform (e.g., server(s) 102), a third-party computing device 106 associated with a third-party service provider 108 (e.g., configured to manage a third-party application 128). Additionally, in some examples, the task, or a portion thereof, can be completed by a computing device associated with a first-party application, such as an application managed by an organization of the user. In such examples, the communication platform can be configured to communicate with the first-party application to cause the task to be completed in response to a triggering action (e.g., action that initiates the workflow).

At operation 704, the communication platform identifies one or more workflows that are available to the user account via the communication platform. In some examples, the communication platform can identify the workflow(s) based on permissions associated with the user account. For example, a user account and/or an organization of the user (e.g., via an administrative account) may establish permissions associated with particular workflows, such that select workflows may be available to be associated with a user account, but other workflows may not. Based on the permissions, the communication platform can cause the select workflows to be presented via the interface.

In some examples, the communication platform can identify the workflow(s) based at least in part on user preferences and/or organization preferences associated with an organization of a user. For example, a user can establish a user preference to view a particular type of workflows for association with the user account. Based on the user preference, the communication platform can cause a presentation of workflow(s) that are associated with the particular type. For another example, an administrator (e.g., administrative account) of an organization of the user can establish an organization preference to render a particular group of workflows available for association with user accounts of the users of the organization. In such an example, the administrator can establish a baseline set of workflows to assist users in identifying and completing preferred processes with regard to the organization.

Additionally or alternatively, in some examples, the communication platform can identify the workflow(s) based on characteristics of the user account. The characteristics can be stored in association with user data 132 in the datastore 126. The characteristics can include an organization identifier associated with an organization of the user, a group or team identifier, a type of user account (e.g., paid, unpaid, temporary, permanent, etc.), employment data (e.g., job position, title, team affiliation, project affiliation, employment location, etc.), qualification (e.g., education, certifications, etc.), third-party application integration (e.g., integration stored in association with user account), user interests (e.g., personal interests, work-related interests, etc.), demographic data (e.g., age, home location, etc.), interaction data (e.g., frequency and/or recency of interactions with other users, with virtual spaces (e.g., communication channels, direct messaging instances, boards, audio and/or video conversations, etc.), and/or other characteristics of the user account. For example, the identified workflow(s) can include workflow(s) that are associated with an organization. Based on a determination that the user account has associated therewith an organization identifier associated with the organization, the communication platform can cause workflow(s) associated with the organization to be presented via the interface.

At operation 706, the communication platform causes a presentation, on an interface of the client, of the one or more workflows. As discussed above with regard to FIGS. 2-6B, the workflow(s) can be presented via an integrations interface, such as integrations interfaces 218, 302, 402, 506, and/or 606. In some examples, the workflow(s) can be presented via the integrations interface in a ranked order, such as based on popularity, user characteristics, and/or other factors. In such examples, the communication platform can be configured to rank the workflow(s) based on one or more factors (e.g., popularity, user characteristics, recency of association with another account, frequency of association with similar user accounts, etc.). In various examples, the communication platform can be configured to cause a presentation of the workflow(s) in different categories, such as workflows that are recommended for the user, popular workflows, organization-related workflows, and/or the like.

At operation 708, the communication platform receives an indication of selection of a first workflow of the one or more workflows. The indication of selection can be received in response to the user selecting an install selectable control, such as install selectable controls 228, 324, and/or 614 associated with the first workflow.

At operation 710, the communication platform determines whether customization of the first workflow is received. As discussed above, in some examples, in response to receiving an indication of selection of the install selectable control, the communication platform can cause a customization window, such as customization window 326 and/or 618, to be presented in association with the integrations interface. The customization window can provide a means by which the user can input one or more customized settings with regard to the first workflow. As discussed above, non-limiting examples of the customized setting(s) can include a virtual space (e.g., workspace, communication channel, direct messaging instance(s), boards, audio and/or video conversations or conferences, etc.) to associate with the workflow, a customized trigger (e.g., triggering action), message contents, time and/or location associated with a message or notification delivery, and/or the like.

Based on a determination that the customization is received (“Yes” at operation 710), the communication platform, at operation 712, associates a customized workflow with the user account. The customized workflow can include the first workflow with the customized setting(s) input via the customization window. The communication platform can store the customized workflow in association with the user account, such as in user data 132 of the datastore 126.

Based on a determination that the customization is not received (“No” at operation 710), the communication platform, at operation 714, associates the first workflow with the user account. The communication platform can store the first workflow in association with the user account, such as in user data 132 of the datastore 126.

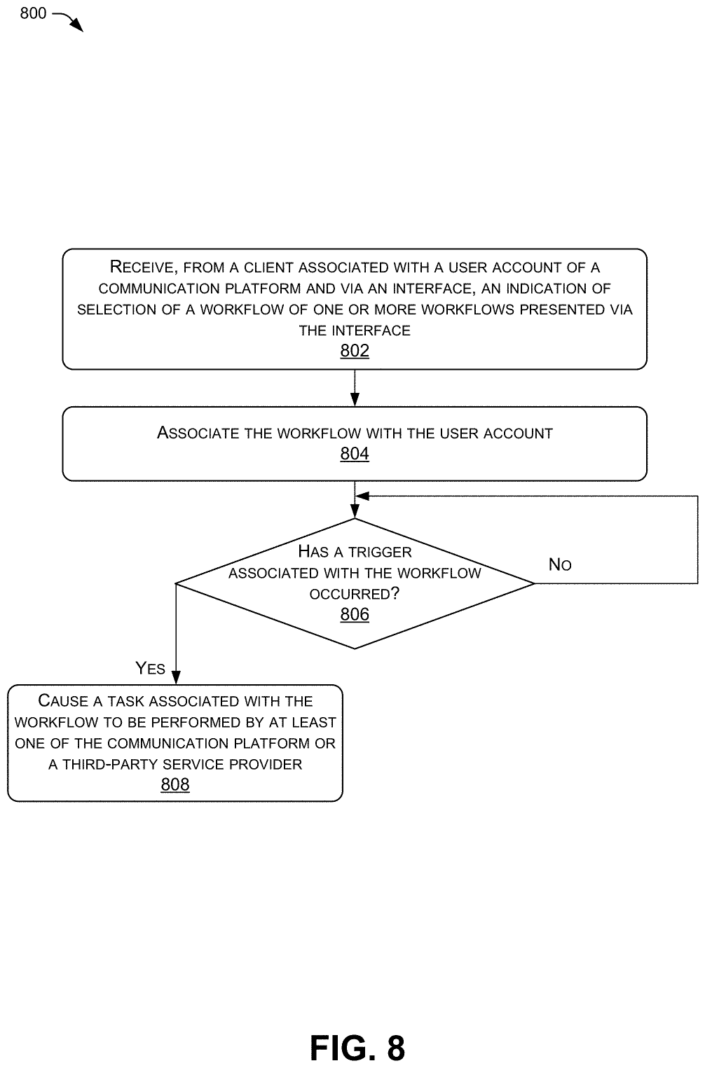

FIG. 8 illustrates an example process 800 for causing a task associated with a workflow to be performed based in part on an occurrence of a triggering action, as described herein. In some instances, some or all of process 800 can be performed by one or more components in the system 100. By way of example and not limitation, the communication platform referred to in process 800 can be representative of a computing device associated with the (communication platform) server(s) 102, a client referred to in process 800 can be representative of the user computing device(s) 104 and/or application 130. However, the process 800 is not limited to being performed by the system 100.

At operation 802, the communication platform receives, from a client associated with a user account of a communication platform and via an interface, an indication of selection of a workflow of one or more workflows presented via the interface. The indication of selection can be received in response to the user selecting an install selectable control, such as install selectable controls 228, 324, and/or 614 associated with the first workflow.

At operation 804, the communication platform associates the workflow with the user account. The communication platform can store the workflow in association with the user account, such as in user data 132 of the datastore 126.

At operation 806, the communication platform determines whether a trigger (e.g., triggering action) associated with the workflow has occurred. In various examples, the trigger can include a trigger associated with the workflow, such as a communication system or developer (e.g., workflow developer, creator, etc.) determined trigger that is stored in association with the workflow. In some examples, the trigger can include a customized trigger input by the user, such as via a customization window. In such examples, the trigger associated with the workflow can be modified based on input from the user.

Based on a determination that the triggering action has not occurred (“No” at operation 806), the communication platform awaits the trigger.

Based on a determination that the triggering action has occurred (“Yes” at operation 806), the communication platform, at operation 808, causes a task associated with the workflow to be performed by at least one of the communication platform or a third-party service provider (e.g., third-party service provider 108). In various examples, the communication platform can automatically cause the task to be performed, such as without further input from the user. In examples in which the task is assigned to or completed by the communication platform (e.g., communication platform generates and transmits an automated message), the communication platform can automatically perform the task without further input from the user. In examples in which the task or a portion thereof is performed at least in part by a third-party application (e.g., third-party application 128) and/or by a first-party application, the communication platform can send a signal to the third-party application and/or the first-party application to cause the respective application to complete the task or the portion thereof. In such examples, the communication platform causes the third-party application and/or the first party application to perform the task or the portion thereof.

In some examples, the communication platform can receive data associated with the task or portion thereof from the third-party application (e.g., third-party computing device 106) and/or the first-party application (e.g., stored on the user computing device 104). In some examples, the communication platform can additionally receive an instruction to present the data in association with the communication platform (e.g., a communication application 130). In such examples, the communication platform can receive the data and cause a presentation thereof on a display associated with the client of the user.

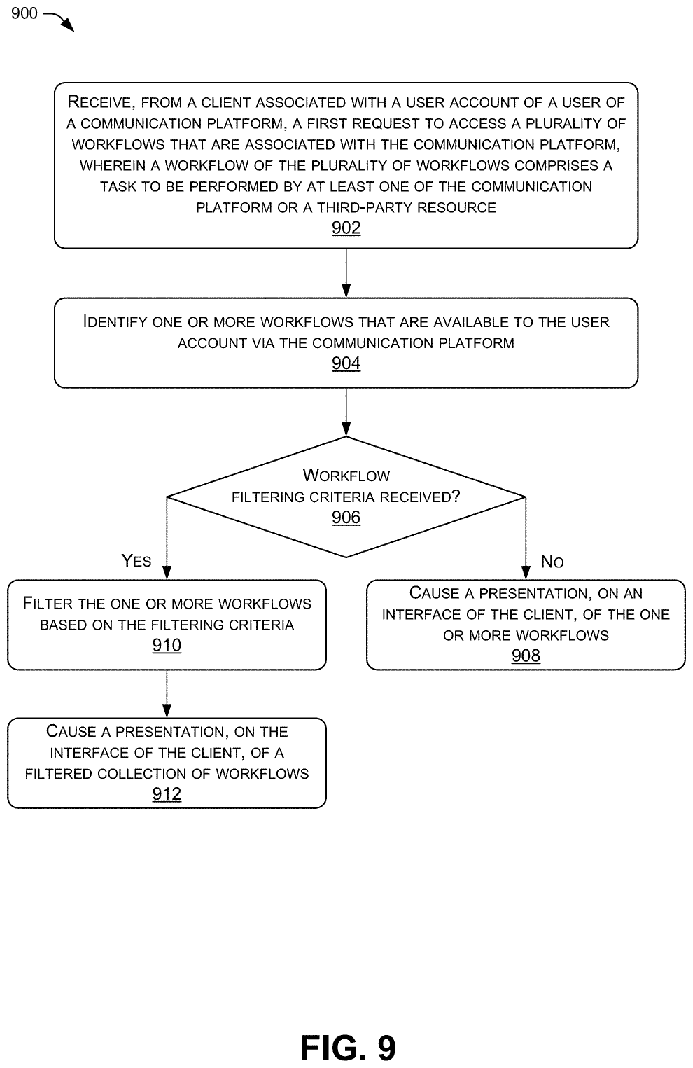

FIG. 9 illustrates an example process 900 for filtering workflows for presentation to a user via an interface, as described herein. In some instances, some or all of process 900 can be performed by one or more components in the system 100. By way of example and not limitation, the communication platform referred to in process 900 can be representative of a computing device associated with the (communication platform) server(s) 102, a client referred to in process 900 can be representative of the user computing device(s) 104 and/or application 130. However, the process 900 is not limited to being performed by the system 100.

At operation 902, the communication platform receives, from a client associated with a user account of a user of a communication platform, a first request to access a plurality of workflows that are associated with the communication platform, wherein a workflow of the plurality of workflows comprises a task to be performed by at least one of the communication platform or a third-party resource. In various examples, the first request can include an indication of selection of an integrations indicator, such as integrations indicator 220 and integrations indicator 306. In various examples, the first request can be submitted via a different indicator associated with the plurality of workflows provided via the communication platform.

As discussed above, each workflow of the plurality of workflows can be associated with a task (e.g., series of steps) completed to accomplish a particular outcome (e.g., a desired outcome). For example, a workflow can include a task to send a welcome message to new members of a particular communication channel. In response to receiving an indication that a new member has joined the particular channel (e.g., triggering action or trigger), the communication platform can generate and transmit a welcome message to at least the new member via a messaging interface in association with the particular channel. The task can be completed by the communication platform (e.g., server(s) 102), a third-party computing device 106 associated with a third-party service provider 108 (e.g., configured to manage a third-party application 128). Additionally, in some examples, the task, or a portion thereof, can be completed by a computing device associated with a first-party application, such as an application managed by an organization of the user. In such examples, the communication platform can be configured to communicate with the first-party application to cause the task to be completed in response to a triggering action (e.g., action that initiates the workflow).

At operation 904, the communication platform identifies one or more workflows that are available to the user account via the communication platform. In some examples, the communication platform can identify the workflow(s) based on permissions associated with the user account. For example, a user account and/or an organization of the user (e.g., via an administrative account) may establish permissions associated with particular workflows, such that select workflows may be available to be associated with a user account, but other workflows may not. Based on the permissions, the communication platform can cause the select workflows to be presented via the interface.

In some examples, the communication platform can identify the workflow(s) based at least in part on user preferences and/or organization preferences associated with an organization of a user. For example, a user can establish a user preference to view a particular type of workflows for association with the user account. Based on the user preference, the communication platform can cause a presentation of workflow(s) that are associated with the particular type. For another example, an administrator (e.g., administrative account) of an organization of the user can establish an organization preference to render a particular group of workflows available for association with user accounts of the users of the organization. In such an example, the administrator can establish a baseline set of workflows to assist users in identifying and completing preferred processes with regard to the organization.

Additionally or alternatively, in some examples, the communication platform can identify the workflow(s) based on characteristics of the user account. The characteristics can be stored in association with user data 132 in the datastore 126. The characteristics can include an organization identifier associated with an organization of the user, a group or team identifier, a type of user account (e.g., paid, unpaid, temporary, permanent, etc.), employment data (e.g., job position, title, team affiliation, project affiliation, employment location, etc.), qualification (e.g., education, certifications, etc.), third-party application integration (e.g., integration stored in association with user account), user interests (e.g., personal interests, work-related interests, etc.), demographic data (e.g., age, home location, etc.), interaction data (e.g., frequency and/or recency of interactions with other users, with virtual spaces (e.g., communication channels, direct messaging instances, boards, audio and/or video conversations, etc.), and/or other characteristics of the user account. For example, the identified workflow(s) can include workflow(s) that are associated with an organization. Based on a determination that the user account has associated therewith an organization identifier associated with the organization, the communication platform can cause workflow(s) associated with the organization to be presented via the interface.

At operation 906, the communication platform determines whether workflow filtering criteria are received. In various examples, the communication platform determines whether the filtering criteria are received in response to receiving input via a search mechanism, such as search mechanisms 230 and/or 406. In some examples, the communication platform determines whether the filtering criteria are received in response to receiving an indication of selection of a filter selectable control, such as filter selectable controls 234 and/or 312, and/or one or more filtering options, such as a first filtering option 308, a second filtering option 310, and/or filtering options 314 presented on the integrations interface. Non-limiting examples of filtering criteria include a number of steps associated with workflows, a source of the workflow (e.g., communication platform, third-party application, first-party application, etc.), an association with team management, managing meetings, tracking statistics and/or other metrics, information and error updates, fun and/or games, creating tasks, generating and/or managing automations in a communication channel or other virtual space, setting notifications and reminders (e.g., for the user 304 to perform an action), personal workflows (e.g., associated with personal or non-work related tasks), and/or the like.

Based on a determination that workflow filtering criteria are not received (“No” at operation 906), the communication platform, at operation 908, causes a presentation, on an interface (e.g., integrations interface) of the client, of the one or more workflows. In some examples, the workflow(s) can be presented via the interface in a ranked order, such as based on popularity, user characteristics, and/or other factors. In such examples, the communication platform can be configured to rank the workflow(s) based on one or more factors (e.g., popularity, user characteristics, recency of association with another account, frequency of association with similar user accounts, etc.). In various examples, the communication platform can be configured to cause a presentation of the workflow(s) in different categories, such as workflows that are recommended for the user, popular workflows, organization-related workflows, and/or the like.

Based on a determination that workflow filtering criteria are received (“Yes” at operation 906), the communication platform, at operation 910, filters the one or more workflows based on the filtering criteria. That is, the communication platform identifies workflow(s) to present based on the filtering criteria.

At operation 912, the communication platform causes a presentation, on the interface of the client, of a filtered collection of workflows, such as filtered collection of workflows 320. In some examples, the communication platform can present the filtered collection of workflows in a ranked order, such as based on the factor(s) (e.g., ranking criteria) described above. In some examples, the communication platform can be configured to provide a pre-determined number (e.g., 15, 20, 25, 50, 100, etc.) of the filtered collection of workflows. That is, the communication platform can limit the presentation to the pre-determined number of highest ranked or most popular workflows.

As such, techniques described herein provide specific, technical solutions to technical problems faced by existing systems, the details of which are described above.

Example Clauses

A: A method, implemented at least in part by one or more computing devices of a communication platform, the method comprising: receiving, from a client associated with a first user account of a first user of the communication platform, a first request to access a plurality of workflows that are associated with the communication platform, wherein a workflow comprises a task to be performed by at least one of the communication platform or a third-party resource; based at least in part on the first request, identifying one or more workflows for the first user account via the communication platform; causing a presentation, on an interface associated with the client, of one or more representations associated the one or more workflows; receiving, from the client via the interface, an indication of selection of a first workflow of the one or more workflows to associate with the first user account; and in response to the indication of selection, associating the first workflow with the first user account.

B: The method of paragraph A, wherein the client is a first client, the method further comprising: identifying a triggering action associated with the first workflow; receiving, from at least one of the first client or a second client associated with a second user account, an indication that the triggering action has occurred; and causing a first task associated with the first workflow to be performed based at least in part on the indication that the triggering action has occurred.

C: The method of either paragraph A or paragraph B, further comprising: identifying one or more characteristics associated with the first user account, wherein identifying the one or more workflows is based at least in part on the one or more characteristics associated with the first user account.

D: The method of any one of paragraphs A-C, further comprising: identifying the plurality of workflows associated with the communication platform; and ranking the plurality of workflows based at least in part on at least one of a number of user accounts that are associated with individual workflows of the plurality of workflows or one or more characteristics associated with the first user account, wherein identifying the one or more workflows for the first user account comprises displaying a number of top-ranked workflows of the plurality of workflows.

E: The method of any one of paragraphs A-D, further comprising: receiving, from the client via the interface, an input comprising a customization of the first workflow, the customization comprising at least one of: a workspace associated with the first workflow; a communication channel associated with the first workflow; a name associated with the first workflow; data to include in a message associated with the first workflow; a time associated with the first workflow; or a triggering action associated with the first workflow.

F: The method any one of paragraphs A-E, further comprising: in response to receiving the indication of selection of the first workflow that is associated with a first task, identifying a second workflow associated with a second task that is related to the first task; and causing a presentation of data associated with the second workflow via the interface in association with the first workflow, wherein the data indicates at least the second task associated with the second workflow.

G: The method of paragraph F, further comprising: receiving, from the client, a second request to associate the second workflow with the first workflow; and associating the second workflow with the first workflow in the first user account, wherein an association causes the second task to be performed in association with the first task.

H: The method of any one of paragraphs A-G, further comprising: identifying a number of other user accounts that are associated with individual workflows of the one or more workflows; and causing a presentation, on the interface associated with the client and in association with the individual workflows, of respective numbers of other user accounts that are associated with the individual workflows.

I: The method of any one of paragraphs A-H, further comprising: receiving, from the client, a second request to filter the one or more workflows based at least in part on a filtering criterion; filtering the one or more workflows based at least in part on the second request; determining that the first workflow meets the filtering criterion; and causing a presentation, on the interface associated with the client, of at least the first workflow.

J: The method of any one of paragraphs A-I, further comprising: receiving, from the client via the interface, a second request to view details associated with the first workflow; identifying data associated with the first workflow; and causing a presentation, on the interface associated with the client, of the data associated with the first workflow.

K: A system associated with a communication platform, wherein the system comprises: one or more processors; and one or more computer-readable media comprising instructions that, when executed by the one or more processors, cause the system to perform operations comprising: receiving, from a client associated with a first user account of a first user of the communication platform, a first request to access a plurality of workflows that are associated with the communication platform, wherein a workflow comprises a task to be performed by at least one of the communication platform or a third-party resource; based at least in part on the first request, identifying one or more workflows for the first user account via the communication platform; causing a presentation, on an interface associated with the client, of one or more representations associated the one or more workflows; receiving, from the client via the interface, an indication of selection of a first workflow of the one or more workflows to associate with the first user account; and in response to the indication of selection, associating the first workflow with the first user account.

L: The system of paragraph K, wherein the client is a first client and the operations further comprise: identifying a triggering action associated with the first workflow; receiving, from at least one of the first client or a second client associated with a second user account, an indication that the triggering action has occurred; and causing a first task associated with the first workflow to be performed based at least in part on the indication that the triggering action has occurred.

M: The system of either paragraph K or paragraph L, the operations further comprising: identifying one or more characteristics associated with the first user account, wherein identifying the one or more workflows is based at least in part on the one or more characteristics associated with the first user account.

N: The system of any one of paragraphs K-M, the operations further comprising: identifying the plurality of workflows associated with the communication platform; and ranking the plurality of workflows based at least in part on at least one of a number of user accounts that are associated with individual workflows of the plurality of workflows or one or more characteristics associated with the first user account, wherein identifying the one or more workflows for the first user account comprises displaying a number of top-ranked workflows of the plurality of workflows.

O: The system of any one of paragraphs K-N, the operations further comprising: receiving, from the client via the interface, an input comprising a customization of the first workflow, the customization comprising at least one of: a workspace associated with the first workflow; a communication channel associated with the first workflow; a name associated with the first workflow; data to include in a message associated with the first workflow; a time associated with the first workflow; or a triggering action associated with the first workflow.

P: The system of any one of paragraphs K-O, the operations further comprising: in response to receiving the indication of selection of the first workflow that is associated with a first task, identifying a second workflow associated with a second task that is related to the first task; and causing a presentation of data associated with the second workflow via the interface in association with the first workflow, wherein the data indicates at least the second task associated with the second workflow

Q: The system of paragraph P, the operations further comprising: receiving, from the client, a second request to associate the second workflow with the first workflow; and associating the second workflow with the first workflow in the first user account, wherein an association causes the second task to be performed in association with the first task.

R: The system of any one of paragraphs K-Q, the operations further comprising: identifying a number of other user accounts that are associated with individual workflows of the one or more workflows; and causing a presentation, on the interface associated with the client and in association with the individual workflows, of respective numbers of other user accounts that are associated with the individual workflows.

S: The system of any one of paragraphs K-R, the operations further comprising: receiving, from the client, a second request to filter the one or more workflows based at least in part on a filtering criterion; filtering the one or more workflows based at least in part on the second request; determining that the first workflow meets the filtering criterion; and causing a presentation, on the interface associated with the client, of at least the first workflow.

T: The system of any one of paragraphs K-S, the operations further comprising: receiving, from the client via the interface, a second request to view details associated with the first workflow; identifying data associated with the first workflow; and causing a presentation, on the interface associated with the client, of the data associated with the first workflow.

U: One or more non-transitory computer-readable media comprising instructions that, when executed by one or more processors, cause the one or more processors to perform operations comprising: receiving, from a client associated with a first user account of a first user of the communication platform, a first request to access a plurality of workflows that are associated with the communication platform, wherein a workflow comprises a task to be performed by at least one of the communication platform or a third-party resource; based at least in part on the first request, identifying one or more workflows for the first user account via the communication platform; causing a presentation, on an interface associated with the client, of one or more representations associated the one or more workflows; receiving, from the client via the interface, an indication of selection of a first workflow of the one or more workflows to associate with the first user account; and in response to the indication of selection, associating the first workflow with the first user account.

V: The one or more non-transitory computer-readable media of paragraph U, wherein the client is a first client and the operations further comprise: identifying a triggering action associated with the first workflow; receiving, from at least one of the first client or a second client associated with a second user account, an indication that the triggering action has occurred; and causing a first task associated with the first workflow to be performed based at least in part on the indication that the triggering action has occurred.

W: The one or more non-transitory computer-readable media of either paragraph U or paragraph V, the operations further comprising: identifying one or more characteristics associated with the first user account, wherein identifying the one or more workflows is based at least in part on the one or more characteristics associated with the first user account.

X: The one or more non-transitory computer-readable media of any one of paragraphs U-W, the operations further comprising: identifying the plurality of workflows associated with the communication platform; and ranking the plurality of workflows based at least in part on at least one of a number of user accounts that are associated with individual workflows of the plurality of workflows or one or more characteristics associated with the first user account, wherein identifying the one or more workflows for the first user account comprises displaying a number of top-ranked workflows of the plurality of workflows.

Y: The one or more non-transitory computer-readable media of any one of paragraphs U-X, the operations further comprising: receiving, from the client via the interface, an input comprising a customization of the first workflow, the customization comprising at least one of: a workspace associated with the first workflow; a communication channel associated with the first workflow; a name associated with the first workflow; data to include in a message associated with the first workflow; a time associated with the first workflow; or a triggering action associated with the first workflow.

Z: The one or more non-transitory computer-readable media of any one of paragraphs U-Y, the operations further comprising: in response to receiving the indication of selection of the first workflow that is associated with a first task, identifying a second workflow associated with a second task that is related to the first task; and causing a presentation of data associated with the second workflow via the interface in association with the first workflow, wherein the data indicates at least the second task associated with the second workflow

AA: The one or more non-transitory computer-readable media of paragraph Z, the operations further comprising: receiving, from the client, a second request to associate the second workflow with the first workflow; and associating the second workflow with the first workflow in the first user account, wherein an association causes the second task to be performed in association with the first task.

AB: The one or more non-transitory computer-readable media of any one of paragraphs U-AA, the operations further comprising: receiving, from the client, a second request to filter the one or more workflows based at least in part on a filtering criterion; filtering the one or more workflows based at least in part on the second request; determining that the first workflow meets the filtering criterion; and causing a presentation, on the interface associated with the client, of at least the first workflow.

While the example clauses described above are described with respect to one particular implementation, it should be understood that, in the context of this document, the content of the example clauses may also be implemented via a method, device, system, a computer-readable medium, and/or another implementation.

### CONCLUSION

While one or more examples of the techniques described herein have been described, various alterations, additions, permutations and equivalents thereof are included within the scope of the techniques described herein.

In the description of examples, reference is made to the accompanying drawings that form a part hereof, which show by way of illustration specific examples of the claimed subject matter. It is to be understood that other examples can be used and that changes or alterations, such as structural changes, can be made. Such examples, changes or alterations are not necessarily departures from the scope with respect to the intended claimed subject matter. While the steps herein can be presented in a certain order, in some cases the ordering can be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

What is claimed is:

1. A method, implemented at least in part by one or more computing devices of a communication platform, the method comprising:
receiving, from a client associated with a first user account of a first user of the communication platform, a first request to access a plurality of workflows that are associated with the communication platform, wherein a workflow comprises a task to be performed by at least one of the communication platform or a third-party resource;
based at least in part on the first request, identifying one or more workflows for the first user account via the communication platform;
causing a presentation, on an interface associated with the client, of one or more representations associated the one or more workflows;
receiving, from the client via the interface, an indication of selection of a first workflow of the one or more workflows to associate with the first user account; and
in response to the indication of selection, associating the first workflow with the first user account.

2. The method of claim 1, wherein the client is a first client, the method further comprising:
identifying a triggering action associated with the first workflow;
receiving, from at least one of the first client or a second client associated with a second user account, an indication that the triggering action has occurred; and
causing a first task associated with the first workflow to be performed based at least in part on the indication that the triggering action has occurred.

3. The method of claim 1, further comprising:
identifying one or more characteristics associated with the first user account,
wherein identifying the one or more workflows is based at least in part on the one or more characteristics associated with the first user account.

4. The method of claim 1, further comprising:
identifying the plurality of workflows associated with the communication platform; and
ranking the plurality of workflows based at least in part on at least one of a number of user accounts that are associated with individual workflows of the plurality of workflows or one or more characteristics associated with the first user account,
wherein identifying the one or more workflows for the first user account comprises displaying a number of top-ranked workflows of the plurality of workflows.

5. The method of claim 1, further comprising:
receiving, from the client via the interface, an input comprising a customization of the first workflow, the customization comprising at least one of:
a workspace associated with the first workflow;
a communication channel associated with the first workflow;
a name associated with the first workflow;
data to include in a message associated with the first workflow;
a time associated with the first workflow; or
a triggering action associated with the first workflow.

6. The method of claim 1, further comprising:
in response to receiving the indication of selection of the first workflow that is associated with a first task, identifying a second workflow associated with a second task that is related to the first task; and
causing a presentation of data associated with the second workflow via the interface in association with the first workflow, wherein the data indicates at least the second task associated with the second workflow.

7. The method of claim 6, further comprising:
receiving, from the client, a second request to associate the second workflow with the first workflow; and
associating the second workflow with the first workflow in the first user account, wherein an association causes the second task to be performed in association with the first task.

8. The method of claim 1, further comprising:
receiving, from the client, a second request to filter the one or more workflows based at least in part on a filtering criterion;
filtering the one or more workflows based at least in part on the second request;
determining that the first workflow meets the filtering criterion; and
causing a presentation, on the interface associated with the client, of at least the first workflow.

9. A system associated with a communication platform, wherein the system comprises:
one or more processors; and
one or more computer-readable media comprising instructions that, when executed by the one or more processors, cause the system to perform operations comprising:
receiving, from a client associated with a first user account of a first user of the communication platform, a first request to access a plurality of workflows that are associated with the communication platform, wherein a workflow comprises a task to be performed by at least one of the communication platform or a third-party resource;
based at least in part on the first request, identifying one or more workflows for the first user account via the communication platform;
causing a presentation, on an interface associated with the client, of one or more representations associated the one or more workflows;
receiving, from the client via the interface, an indication of selection of a first workflow of the one or more workflows to associate with the first user account; and
in response to the indication of selection, associating the first workflow with the first user account.

10. The system of claim 9, wherein the client is a first client, the operations further comprising:
identifying a triggering action associated with the first workflow;
receiving, from at least one of the first client or a second client associated with a second user account, an indication that the triggering action has occurred; and
causing a first task associated with the first workflow to be performed based at least in part on the indication that the triggering action has occurred.

11. The system of claim 9, the operations further comprising:
identifying one or more characteristics associated with the first user account,
wherein identifying the one or more workflows is based at least in part on the one or more characteristics associated with the first user account.

12. The system of claim 9, the operations further comprising:
identifying the plurality of workflows associated with the communication platform; and
ranking the plurality of workflows based at least in part on at least one of a number of user accounts that are associated with individual workflows of the plurality of workflows or one or more characteristics associated with the first user account,
wherein identifying the one or more workflows for the first user account comprises displaying a number of top-ranked workflows of the plurality of workflows.

13. The system of claim 9, the operations further comprising:
receiving, from the client via the interface, an input comprising a customization of the first workflow, the customization comprising at least one of:
a workspace associated with the first workflow;
a communication channel associated with the first workflow;
a name associated with the first workflow;
data to include in a message associated with the first workflow;
a time associated with the first workflow; or
a triggering action associated with the first workflow.

14. The system of claim 9, the operations further comprising:
in response to receiving the indication of selection of the first workflow that is associated with a first task, identifying a second workflow associated with a second task that is related to the first task; and
causing a presentation of data associated with the second workflow via the interface in association with the first workflow, wherein the data indicates at least the second task associated with the second workflow.

15. The system of claim 14, further comprising:
receiving, from the client, a second request to associate the second workflow with the first workflow; and
associating the second workflow with the first workflow in the first user account, wherein an association causes the second task to be performed in association with the first task.

16. The system of claim 9, further comprising:
receiving, from the client, a second request to filter the one or more workflows based at least in part on a filtering criterion;
filtering the one or more workflows based at least in part on the second request;
determining that the first workflow meets the filtering criterion; and
causing a presentation, on the interface associated with the client, of at least the first workflow

17. One or more non-transitory computer-readable media comprising instructions that, when executed by one or more processors, cause the one or more processors to perform operations comprising:
receiving, from a client associated with a first user account of a first user of the communication platform, a first request to access a plurality of workflows that are associated with the communication platform, wherein a workflow comprises a task to be performed by at least one of the communication platform or a third-party resource;
based at least in part on the first request, identifying one or more workflows for the first user account via the communication platform;
causing a presentation, on an interface associated with the client, of one or more representations associated the one or more workflows;
receiving, from the client via the interface, an indication of selection of a first workflow of the one or more workflows to associate with the first user account; and
in response to the indication of selection, associating the first workflow with the first user account.

18. The one or more non-transitory computer-readable media of claim 17, wherein the client is a first client, the operations further comprising:
identifying a triggering action associated with the first workflow;
receiving, from at least one of the first client or a second client associated with a second user account, an indication that the triggering action has occurred; and
causing a first task associated with the first workflow to be performed based at least in part on the indication that the triggering action has occurred.

19. The one or more non-transitory computer-readable media of claim 17, the operations further comprising:
identifying one or more characteristics associated with the first user account,
wherein identifying the one or more workflows is based at least in part on the one or more characteristics associated with the first user account.

20. The one or more non-transitory computer-readable media of claim 17, the operations further comprising:
identifying the plurality of workflows associated with the communication platform; and
ranking the plurality of workflows based at least in part on at least one of a number of user accounts that are associated with individual workflows of the plurality of workflows or one or more characteristics associated with the first user account,
wherein identifying the one or more workflows for the first user account comprises displaying a number of top-ranked workflows of the plurality of workflows.
